(19) United States
(12) Patent Application Publication
(10) Pub. No.: US 2021/0063905 A1
(43) Pub. Date: Mar. 4, 2021

(54) ELECTROSTATIC LATENT IMAGE DEVELOPING TONER SET AND ELECTROPHOTOGRAPHIC IMAGE FORMING METHOD

(71) Applicant: Konica Minolta, Inc., Tokyo (JP)

(72) Inventors: Takaki KAWAMURA, Tokyo (JP); Noboru UEDA, Tokyo (JP); Natsuki ITO, Tokyo (JP); Yusuke TAKIGAURA, Tokyo (JP); Ami MOTOHASHI, Tokyo (JP)

(21) Appl. No.: 16/993,352

(22) Filed: Aug. 14, 2020

(30) Foreign Application Priority Data
Aug. 29, 2019 (JP) 2019-156261

(51) Int. Cl. G03G 9/09; G03G 9/087; G03G 15/08; G03G 15/01

(52) U.S. Cl. CPC G03G 9/09; G03G 15/0121; G03G 15/08; G03G 9/08755

(57) ABSTRACT

An electrostatic latent image developing toner set of the present invention is an electrostatic latent image developing toner set including at least a yellow toner, a magenta toner, and a cyan toner, wherein when exothermic peak top temperatures during decreasing temperature in differential scanning calorimetry of the yellow toner, the magenta toner, and the cyan toner are assumed to be P(Y), P(M), and P(C), respectively, the exothermic peak top temperatures satisfy the following expression (1).

70≤P(Y)≤P(M)≤P(C)≤90(° C.) (1)

### CROSS-REFERENCE TO RELATED APPLICATIONS

The entire disclosure of Japanese Patent Application No. 2019-156261 filed on Aug. 29, 2019 is incorporated herein by reference in its entirety.

### BACKGROUND

### Technological Field

The present invention relates to an electrostatic latent image developing toner set and an electrophotographic image forming method, and in more detail, relates to an electrostatic latent image developing toner set and the like that suppress adhesion of wax and enable compatibility between fixation separability and a gloss memory property.

### Description of the Related Art

In recent years, an electrostatic latent image developing toner (hereinafter, simply referred to as “toner”) that is thermally fixed at a lower temperature has been demanded in an image forming apparatus of an electrophotographic system. In such a toner, the melting temperature and melt viscosity of a binder resin need to be lowered.

Thus, in the past, a toner in which low-temperature fixability has been improved by adding a crystalline resin, such as a crystalline polyester resin, as a fixing aid has been proposed (see, for example, JP 2012-168505A).

Moreover, a toner in which low-temperature fixability has been improved by adding a low-melting-point release agent is proposed (see, for example, JP 2010-145549A).

In such a toner containing a crystalline resin or a low-melting-point release agent, when wax existing on the surface layer of an image comes into contact with a member such as a conveyance roller during conveying the image while remaining in a molten state, the wax is cooled and sticks fast at the time of coming into contact with the member, so that a problem, such as conveyance failure, contamination inside a machine, or occurrence of unevenness of gloss due to transfer of excessively existing wax onto an image, is brought about. Therefore, it is conceivable to reduce the release agent, but a problem is that the gloss memory property and the fixation separability are degraded by reducing the release agent.

### SUMMARY

The present invention has been completed in view of the problems and circumstances, and objects of the present invention are to provide an electrostatic latent image developing toner set and an electrophotographic image forming method that suppress adhesion of wax and enable compatibility between fixation separability and a gloss memory property.

The present inventors have conducted studies on the causes and the like of the problems in order to solve the problems and, in the process of the studies, have found that an electrostatic latent image developing toner set that suppresses the adhesion of wax and enables compatibility between the fixation separability and the gloss memory property is obtained by an electrostatic latent image developing toner set in which exothermic peak top temperatures during decreasing temperature by differential scanning calorimetry of electrostatic latent image developing toners satisfy a particular relationship in the toners of at least a yellow toner, a magenta toner, and a cyan toner.

To achieve at least one of the abovementioned objects, according to an aspect of the present invention, an electrostatic latent image developing toner set reflecting one aspect of the present invention is an electrostatic latent image developing toner set including at least a yellow toner, a magenta toner, and a cyan toner, wherein when exothermic peak top temperatures during decreasing temperature in differential scanning calorimetry of the yellow toner, the magenta toner, and the cyan toner are assumed to be P(Y), P(M), and P(C), respectively, the exothermic peak top temperatures satisfy the following expression (1).

70≤P(Y)≤P(M)≤P(C)≤90 (° C.) (1)

To achieve at least one of the abovementioned objects, according to another aspect of the present invention, an electrostatic latent image developing toner set reflecting one aspect of the present invention is an electrostatic latent image developing toner set including at least a black toner, a yellow toner, a magenta toner, and a cyan toner, wherein

when exothermic peak top temperatures during decreasing temperature in differential scanning calorimetry of the black toner, the yellow toner, the magenta toner, and the cyan toner are assumed to be P(Bk), P(Y), P(M), and P(C), respectively, the exothermic peak top temperatures satisfy the following expression (2).

70≤P(Bk)≤P(Y)≤P(M)≤P(C)90 (° C.) (2)

By the abovementioned means of the present invention, an electrostatic latent image developing toner set and an electrophotographic image forming method that suppress the adhesion of wax and enable compatibility between the fixation separability and the gloss memory property can be provided.

The manifestation mechanism or action mechanism of the effects of the present invention has not been made clear, but it is inferred as follows.

In the electrostatic latent image developing toner set of the present invention, the exothermic peak top temperatures during decreasing temperature by differential scanning calorimetry of the toners are in the range of 70 to 90° C., and the exothermic peak top temperatures of the color toners satisfy the relational expression: P(Y)≤P(M)≤P(C), and thereby the adhesion of wax to the member which the wax comes into contact with can be suppressed when a toner image is discharged after fixation while being cooled, and an image without a quality defect, such as a gloss memory property, can be obtained without deteriorating the fixation separability.

The exothermic peak top temperatures of the toners are in the range of 70 to 90° C., and thereby the adhesion of wax to the member which the wax comes into contact with can be suppressed as a single layer (monochromatic color) when a toner image is discharged after fixation while being cooled.

The reason is as follows: the exothermic peak top temperatures of the toners each have a characteristic of being a temperature lower than the temperature at which a release agent on the surface of an image solidifies (crystallizes); and the temperature at the time when a toner image is discharged to come into contact with the member is lower than 70° C., and therefore when a toner has an exothermic peak temperature of 70° C. or higher, the release agent existing on the surface of the image thereby solidifies at a temperature higher than the exothermic peak top temperature, so that the adhesion of wax, when coming into contact with a roller, can be suppressed.

Moreover, when an exothermic peak top temperature of a toner is higher than 90° C., the crystallizing speed of a release agent on the surface of an image after fixation is too fast, and therefore the image is whitened, or the exothermic peak temperature is high, that is, the endothermic peak temperature is also high and therefore the amount of a release agent bleeding out onto the surface of the image is extremely small, so that the fixation separability or the low-temperature fixability is degraded.

On the other hand, in the case of an image (multi-color) obtained by superimposing the color toners, the amount of wax on the image increases due to an increase in the total amount of the toners adhering, so that the adhesion of wax cannot be suppressed only by the settings of the exothermic peak top temperatures of the toners.

As a result of studies, it has been found that the exothermic peak top temperatures of the color toners need to satisfy relational expression (1): P(Y)≤P(M)≤P(C) when a superimposed image is formed.

Superimposition of images is performed in such a way that the images are transferred onto paper in the order of black, cyan, magenta, and yellow as a matter of a process of forming an image. Moreover, the peak top temperatures may be lowered in the order of cyan, magenta, and yellow because another color is not placed on black.

This is because an exothermic peak top temperature of an image layer which is disposed lower at the time when a superimposed image is formed is higher, thereby crystallization progresses earlier from the lower layer side when pressure is applied to the toner images by the roller which comes into contact with the toner images at the time when the toner images are discharged after fixation while being cooled, and therefore bleed out of a release agent onto the surface of the image can moderately be suppressed.

Accordingly, it is considered that the exothermic peak top temperatures of the color toners need to satisfy the relational expression (1) in order to realize the following: when a superimposed image is fixed, the image is discharged while allowing wax to bleed out of a layer in the vicinity of the surface of the image and retaining wax in toners in lower layers.

As a result, even when the amount of the toners adhering increases to make the amount of wax large in a superimposed image, the amount of wax bleeding out onto the surface of the image can be made small, so that the wax adhesion property to a member which comes into contact with the wax can be suppressed. Moreover, the wax adhesion property can be suppressed by the abovementioned means, while it is unnecessary to excessively suppress the amount of wax bleeding out during fixation, and therefore it is inferred that the abovementioned means does not degrade the gloss memory and the fixation separability.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 is a graph showing one example of an exothermic curve and a differential curve thereof during decreasing temperature by DSC;

FIG. 2 is a graph showing an example of enlarging an exothermic curve and a differential curve thereof during decreasing temperature by DSC;

FIG. 3 is a graph showing another example of an exothermic curve and a differential curve thereof during decreasing temperature by DSC; and

FIG. 4 is a schematic diagram showing one example of the whole configuration of an electrophotographic image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

An electrostatic latent image developing toner set of the present invention is an electrostatic latent image developing toner set including at least a yellow toner, a magenta toner, and a cyan toner, wherein when exothermic peak top temperatures during decreasing temperature in differential scanning calorimetry of the yellow toner, the magenta toner, and the cyan toner are assumed to be P(Y), P(M), and P(C), respectively, the exothermic peak top temperatures satisfy the expression (1). This characteristic is a technical characteristic that is common to or corresponds to the following aspects.

As an aspect of the present invention, the electrostatic latent image developing toner set of the present invention is an electrostatic latent image developing toner set including at least a black toner, a yellow toner, a magenta toner, and a cyan toner from the viewpoint of exhibition of the effects, wherein when exothermic peak top temperatures during decreasing temperature in differential scanning calorimetry of the black toner, the yellow toner, the magenta toner, and the cyan toner are assumed to be P(Bk), P(Y), P(M), and P(C), respectively, the exothermic peak top temperatures satisfy the expression (2).

Further, the exothermic peak top temperatures of the black toner, the yellow toner, the magenta toner, and the cyan toner during decreasing temperature by differential scanning calorimetry of the toners preferably satisfy the expressions (3) to (6).

Moreover, the toners each preferably contain at least a styrene/acrylic resin as a binder resin from the viewpoint of suppressing excessive bleed out of a release agent and suppressing adhesion of wax during fixation.

Furthermore, the toners each preferably contain at least a crystalline resin as a binder resin from the viewpoint of suppressing excessive bleed out of a release agent and suppressing adhesion of wax during fixation.

In addition, the crystalline resin preferably contains a crystalline polyester from the viewpoint of facilitating crystallization of a release agent in a toner and suppressing adhesion of wax.

An electrophotographic image forming method of the present invention is an electrophotographic image forming method using at least a yellow toner, a magenta toner, and a cyan toner, wherein the electrostatic latent image developing toner set of the present invention is used.

Hereinafter, detailed description on the present invention and its constituents, and on the embodiments/aspects for carrying out the present invention will be made. It is to be noted that “to” in the present application is used with the meaning that numerical values written before and after it are included as a lower limit value and an upper limit value, respectively.

≤≤Overview of Electrostatic Latent Image Developing Toner Set of the Present Invention>>

The electrostatic latent image developing toner set of the present invention is an electrostatic latent image developing toner set including at least a yellow toner, a magenta toner, and a cyan toner, wherein

when exothermic peak top temperatures during decreasing temperature in differential scanning calorimetry of the yellow toner, the magenta toner, and the cyan toner are assumed to be P(Y), P(M), and P(C), respectively, the exothermic peak top temperatures satisfy the following expression (1).

70≤P(Y)≤P(M)≤P(C)≤90 (° C.) (1)

Further, the electrostatic latent image developing toner set of the present invention is an electrostatic latent image developing toner set including at least a black toner, a yellow toner, a magenta toner, and a cyan toner, wherein

when exothermic peak top temperatures during decreasing temperature in differential scanning calorimetry of the black toner, the yellow toner, the magenta toner, and the cyan toner are assumed to be P(Bk), P(Y), P(M), and P(C), respectively, the exothermic peak top temperatures satisfy the following expression (2).

70≤P(Bk)≤P(Y)≤P(M)≤P(C) 90 (° C.) (2)

The exothermic peak top temperatures of the black toner, the yellow toner, the magenta toner, and the cyan toner during decreasing temperature by differential scanning calorimetry of the toners preferably satisfy the following expressions (3) to (6).

70≤P(Bk)≤85 (° C.) (3)

72≤P(Y)≤86 (° C.) (4)

73≤P(M)≤87 (° C.) (5)

74≤P(C)≤88 (° C.) (6)

The “exothermic peak top temperature during decreasing temperature by differential scanning calorimetry” in the present invention refers to a temperature based on the following definition.

[Definition of Exothermic Peak Top Temperature rₑ During Decreasing Temperature]

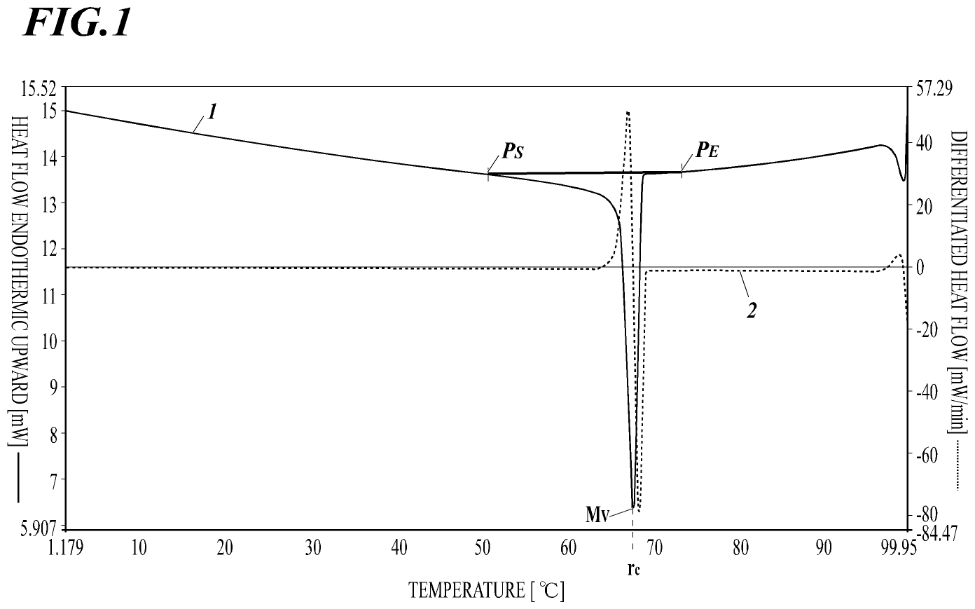

The definition of the exothermic peak top temperature rₑ during decreasing temperature will be described with reference to FIGS. 1 to 3.

In FIG. 1, a curve 1 is an exothermic curve during decreasing temperature by DSC, and a curve 2 is a differential curve of the curve 1 (hereinafter, curve 2 is also referred to as “differential curve 2”).

In the p0resent invention, the starting point and ending point of an exothermic peak in the curve 1 are defined as the starting point/ending point of a change in inclination of the differential curve 2.

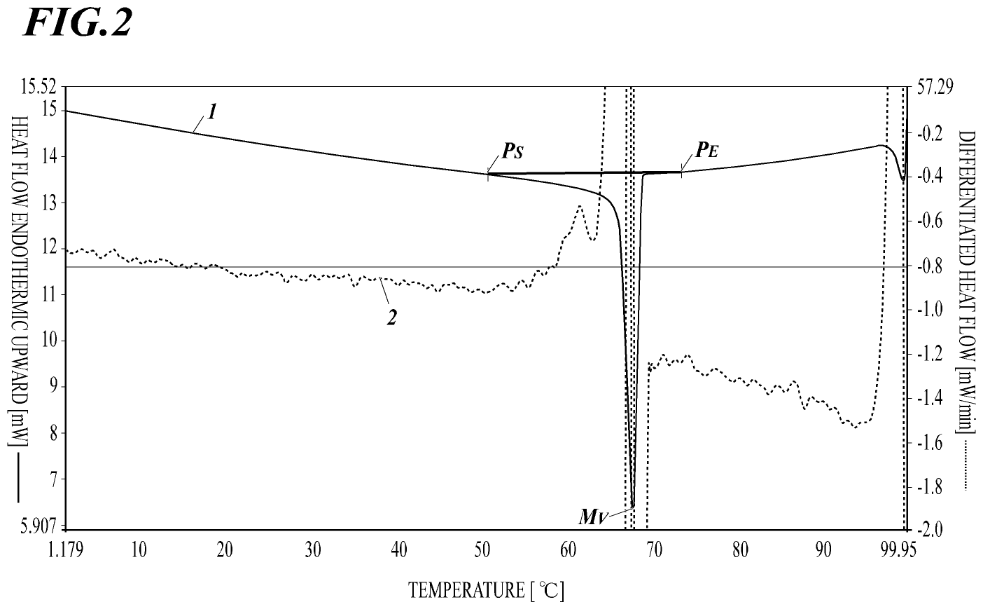

FIG. 2 is obtained by enlarging the curve 2. The starting point (in the vicinity of 51° C. in the example in FIGS. 1 and 2) and ending point (in the vicinity of 73° C. in the example in FIGS. 1 and 2) of the change in the inclination of the differential curve 2 are regarded as the starting point Pₛ and ending point P_{E} of the exothermic peak in the curve 1, respectively. The exothermic peak top temperature rₑ is regarded as a temperature at the minimum point M_{V} in the range from the starting point P_{S} to the ending point P_{E} of the peak, the starting point P_{S} and the ending point P_{E} each defined above, but when a plurality of minimum points exist like the example shown in

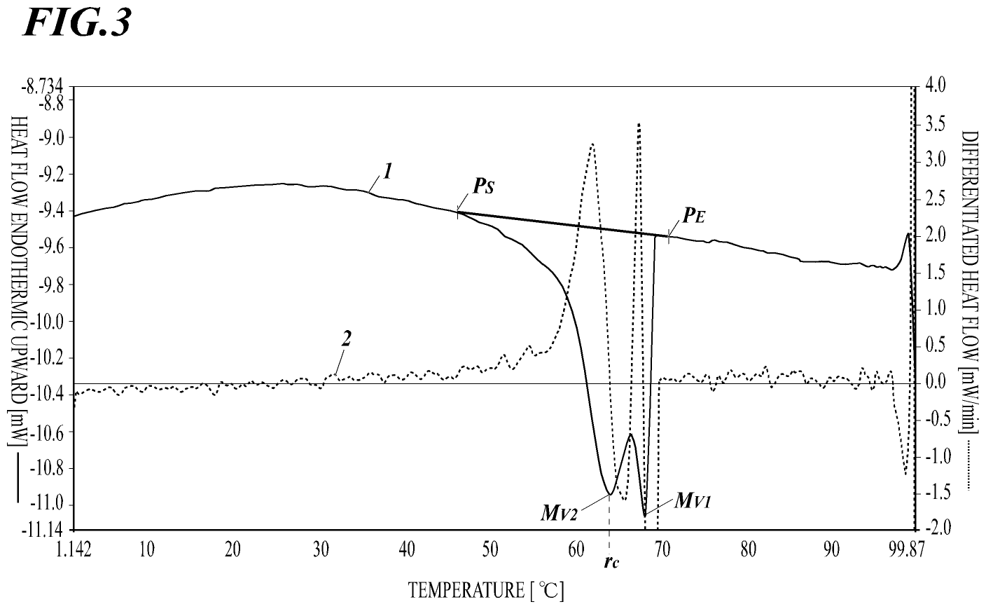

FIG. 3, a peak at a lowest temperature among the minimum points having an intensity of ⅓ or more to the intensity of a minimum point whose intensity is largest is regarded as the exothermic peak top, and the temperature at this exothermic peak top is defined as the exothermic peak top temperature rₑ. Specifically, in the example in FIG. 3, the minimum point M_{V1} whose intensity is largest exists around 68° C., but the exothermic peak top temperature rₑ according to the present invention is the temperature at M_{V2}, which is a minimum point at a lower temperature (around 64° C.).

The exothermic peak top temperature rₑ during decreasing temperature by DSC of each of the black toner, the yellow toner, the magenta toner, and the cyan toner that constitute the electrostatic latent image developing toner set of the present invention is in the range of 70 to 90° C., preferably in the range of 70 to 88° C. When the exothermic peak top temperature rₑ of each of the toners is lower than 70° C., the amount of the component that crystallizes when the toner is produced is thereby easily made large, and therefore print blocking resistance decreases. Moreover, when the exothermic peak top temperature rₑ is higher than 90° C., the low-temperature fixability decreases.

[Measurement of Exothermic Peak Top Temperature during Decreasing Temperature]

A sample in an amount of 5 mg is sealed in an aluminum pan KIT NO. B0143013 and set in a sample holder of a thermal analyzer Diamond DSC (manufactured by PerkinElmer Inc.), and the temperature is changed by heating, cooling, and heating in this order. The temperature is increased from 0° C. to 100° C. at a temperature increase rate of 10° C./min to retain the temperature at 100° C. for one minute during the first and second heating, and the temperature is decreased from 100° C. to 0° C. at a temperature decrease rate of 10° C./min to retain the temperature at 0° C. for one minute during the cooling. The temperature at the exothermic peak top in an endothermic curve which is obtained during the cooling is determined to be the “exothermic peak top temperature”.

That the black toner, the yellow toner, the magenta toner, and the cyan toner that constitute the electrostatic latent image developing toner set of the present invention satisfy the relational expressions (1) to (6) can be achieved by appropriately adjusting the type of the release agent (such as, for example, an ester wax and a hydrocarbon wax), the type of the binder resin (such as a styrene/acrylic resin and a crystalline polyester resin), and the mixing ratio of the release agent to the binder resin.

Hereinafter, the constituents of the present invention will be described in detail.

[1] Electrostatic Latent Image Developing Toner Set

The electrostatic latent image developing toner set of the present invention is an electrostatic latent image developing toner including at least a yellow toner, a magenta toner, and a cyan toner, and each electrostatic latent image developing toner according to the present invention (hereinafter, also simply referred to as “toner”) preferably contains a toner particle containing a toner matrix particle containing at least a binder resin, a colorant, and a release agent.

Moreover, the toner matrix particle according to the present invention may contain various internal additives, such as a charge controlling agent or a surfactant, as necessary in addition to the binder resin, the colorant, and the release agent.

It is to be noted that in the present invention, the “toner” refers to an aggregate of “toner particles”, and the toner particle refers to a substance obtained by adding an external additive to the abovementioned toner matrix particle. Moreover, in the following description, the toner matrix particle is also simply referred to as “toner particle” when the toner matrix particle and the toner particle need not to be particularly distinguished.

[1.1] Binder Resin

The binder resin according to the present invention preferably contains at least an amorphous resin and a crystalline resin. The binder resin preferably contains a styrene/acrylic resin as the amorphous resin and preferably contains a crystalline polyester resin as the crystalline resin. Moreover, the binder resin preferably contains as the binder resin an amorphous polyester resin or a modified polyester resin (hybrid amorphous polyester resin) in which part of the amorphous polyester resin has been modified in addition to the crystalline polyester resin.

[Amorphous Resin]

The amorphous resin to be contained as the binder resin preferably contains a styrene/acrylic resin, and may be one or more. Other examples of the amorphous resin include amorphous polyester resins such as a vinyl resin, a urethane resin, a urea resin, and a styrene/acrylic-modified polyester resin. Among others, the amorphous resin is preferably a vinyl resin from the viewpoint of easily controlling thermoplasticity.

<Vinyl Resin>

The vinyl resin is, for example, a polymerized product of a vinyl compound, and examples thereof include an acrylic acid ester resin, a styrene/acrylic acid ester resin, and an ethylene-vinyl acetate resin. Among others, a styrene/acrylic acid ester resin (styrene/acrylic resin) is preferable from the viewpoint of plasticity during thermal fixation.

(Styrene/Acrylic Resin)

The styrene/acrylic resin is formed by subjecting at least a styrene monomer and a (meth)acrylic acid ester monomer to addition polymerization. The styrene monomer includes styrene represented by a structural formula CH₂═CH—C₆H₅, and styrene derivatives having a known side chain or functional group in the styrene structure.

((Meth)Acrylic Acid Ester Monomer)

The (meth)acrylic acid ester monomer includes an acrylic acid ester or a methacrylic acid ester represented by CH(Rₐ)═CHCOOR_{b} (wherein, Rₐ represents a hydrogen atom or a methyl group, and R_{b} represents an alkyl group having 1 to 24 carbon atoms), and acrylic acid ester derivatives or methacrylic acid ester derivatives having a known side chain or functional group in the structures of these esters.

Examples of the (meth)acrylic acid ester monomer include: acrylic acid ester monomers, such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and methacrylic acid esters, such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate.

It is to be noted that the “(meth)acrylic acid ester monomer” in the present specification is a general term of an “acrylic acid ester monomer” and a “methacrylic acid ester monomer” and means one or both of them. For example, “methyl (meth)acrylate” means one or both of “methyl acrylate” and “methyl methacrylate”.

The (meth)acrylic acid ester monomer may be one or more. For example, any of forming a copolymer using a styrene monomer and two or more acrylic acid ester monomers, forming a copolymer using a styrene monomer and two or more methacrylic acid ester monomers, and forming a copolymer using a styrene monomer, an acrylic acid ester monomer, and a methacrylic acid ester monomer together can be performed.

(Styrene Monomer)

Examples of the styrene monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene.

(Preferred Constitution of Styrene/Acrylic Resin)

From the viewpoint of controlling plasticity of the styrene/acrylic resin, the content of the constituent unit derived from the styrene monomer in the styrene/acrylic resin is preferably in the range of 40 to 90% by mass Moreover, the content by percentage of the constituent unit derived from the (meth)acrylic acid ester monomer in the styrene/acrylic resin is preferably in the range of 10 to 60% by mass

(Additional Monomer)

The styrene/acrylic resin may further contain a constituent unit derived from an additional monomer other than the styrene monomer and the (meth)acrylic acid ester monomer. The additional monomer is preferably a compound that forms an ester bond with a hydroxy group (—OH) derived from a polyhydric alcohol or a carboxy group (—COOH) derived from a polyvalent carboxylic acid. That is, the styrene/acrylic resin is preferably a polymerized product obtained in such a way that a compound (amphoteric compound) which is addition-polymerizable with the styrene monomer and the (meth)acrylic acid ester monomer and has a carboxy group or a hydroxy group is further polymerized.

(Amphoteric Compound)

Examples of the amphoteric compound include: compounds having a carboxy group, such as acrylic acid, methacrylic acid, maleic acid, itaconic acid, cinnamic acid, fumaric acid, a maleic acid monoalkyl ester, and an itaconic acid monoalkyl ester; and compounds having a hydroxy group, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, and polyethylene glycol mono(meth)acrylate.

(Preferred Content of Constituent Unit Derived from Amphoteric Compound)

The content of the constituent unit derived from the amphoteric compound in the styrene/acrylic resin is preferably in the range of 0.5 to 20% by mass.

(Method for Synthesizing Styrene/Acrylic Resin)

The styrene/acrylic resin can be synthesized by a method for polymerizing a monomer using a known oil-soluble or water-soluble polymerization initiator. Examples of the oil-soluble polymerization initiator include an azo-based or diazo-based polymerization initiator and a peroxide-based polymerization initiator.

(Azo-based or Diazo-based Polymerization Initiator)

Examples of the azo-based or diazo-based polymerization initiator include 2,2′-azobis-(2,4-dimethylvarelonitrile), 2,2′-azobisisobutyronitrile, 1,1′-azobis(cyclohexane-1-carbonitrile), 2,2′-azobis-4-methoxy-2,4-dimethylvarelonitrile, and azobisisobutyronitrile.

(Peroxide-based Polymerization Initiator)

Examples of the peroxide-based polymerization initiator include benzoyl peroxide, methyl ethyl ketone peroxide, diisopropyl peroxy carbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane, and tris-(t-butylperoxy)triazine.

(Water-soluble Radical Polymerization Initiator)

Moreover, when a resin particle of the styrene/acrylic resin is synthesized by an emulsion polymerization method, a water-soluble radical polymerization initiator is usable as a polymerization initiator. Examples of the water-soluble radical polymerization initiator include: persulfates, such as potassium persulfate and ammonium persulfate, azobisaminodipropane acetate, azobiscyanovaleric acid and salts thereof, and hydrogen peroxide.

(Preferred Weight Average Molecular Weight of Amorphous Resin)

The weight average molecular weight (Mw) of the amorphous resin is preferably in the range of 5000 to 150000, more preferably in the range of 10000 to 70000 from the viewpoint of easily controlling the plasticity.

[Crystalline Resin]

The crystalline resin according to the present invention refers to a resin which does not have a step-wise endothermic change but has a definite endothermic peak in DSC of the crystalline resin or the toner particle. The definite endothermic peak specifically means a peak having a half-value width of an endothermic peak within 15° C., the endothermic peak measured at a temperature increase rate of 10° C./min in DSC.

The crystalline polyester resin refers to a substance which is a polyester resin among such crystalline resins.

It is to be noted that in the present invention, the binder resin contains at least a crystalline polyester resin, but a crystalline resin other than the crystalline polyester resin can also be used in a range where exhibition of the effects of the present invention is not inhibited. It is to be noted that such a crystalline resin is not particularly limited, a known crystalline resin can be used, and the crystalline resin may be one or more.

(Melting Point of Crystalline Polyester Resin)

The melting point (Tm) of the crystalline polyester resin is preferably in the range of 50 to 90° C., more preferably in the range of 60 to 80° C. from the viewpoint of obtaining a sufficient low-temperature fixability and high-temperature storage property.

(Method for Measuring Melting Point)

The melting point of the binder resin can be measured by DSC. Specifically, a sample in an amount of 5 mg is sealed in an aluminum pan KIT NO. B0143013 and set in a sample holder of a thermal analyzer Diamond

DSC (manufactured by PerkinElmer Inc.), and the temperature is changed by increasing temperature, decreasing temperature, and increasing temperature in this order.

The temperature is increased from 0° C. to 100° C. at a temperature increase rate of 10° C./min to retain the temperature at 100° C. for one minute during the first and second temperature increase. The temperature is decreased from 100° C. to 0° C. at a temperature decrease rate of 10° C./min to retain the temperature at 0° C. for one minute during decreasing temperature. Measurement is performed to determine the temperature at the peak top of the endothermic peak in an endothermic curve which is obtained during the second heating as the melting point (Tm).

(Preferred Weight Average Molecular Weight and Number Average Molecular Weight of Crystalline Polyester Resin)

Moreover, the crystalline polyester resin preferably has a weight average molecular weight (Mw) in the range of 5000 to 50000 and a number average molecular weight (Mn) in the range of 2000 to 10000 from the viewpoint of low-temperature fixability and stable exhibition of gloss in a final image.

(Method for Measuring Weight Average Molecular Weight and Number Average Molecular Weight)

The weight average molecular weight (Mw) and the number average molecular weight (Mn) can be determined from a molecular weight distribution measured by gel permeation chromatography (GPC) as follows.

A sample is added in tetrahydrofuran (THF) in such a way as to make the concentration 1 mg/mL, and after dispersion processing is performed using an ultrasonic disperser at room temperature for 5 minutes, processing is performed with a membrane filter having a pore size of 0.2 μm to prepare a sample liquid. THF is allowed to flow as a carrier solvent at a flow rate of 0.2 mL/min using a GPC apparatus HLC-8120GPC (manufactured by Tosoh Corporation) and columns “TSKguardcolumn+TSKgel Super HZM-M Triple” (manufactured by Tosoh Corporation) while the column temperature is retained at 40° C. The prepared sample liquid in an amount of 10 μL is injected together with the carrier solvent into the GPC apparatus to subject a sample to detection using a refractive index detector (RI detector). Subsequently, the molecular weight distribution of the sample is calculated using a calibration curve measured using 10 points of monodispersed polystyrene standard particles.

(Content of Crystalline Resin in Toner Matrix Particle)

The content of the crystalline resin in the toner matrix particle is preferably in the range of 5 to 20% by mass from the viewpoint of compatibility between satisfactory low-temperature fixability and transfer performance in a high-temperature/ high-humidity environment. When the content is 5% by mass or more, the low-temperature fixability of a toner image to be formed is sufficient. Moreover, when the content is 20% by mass or less, the transfer performance is sufficient.

<Constitution of Crystalline Polyester Resin>

The crystalline polyester resin is obtained by a polycondensation reaction between a divalent-or-higher carboxylic acid (polyvalent carboxylic acid) and a dihydric-or-higher alcohol (polyhydric alcohol).

(Dicarboxylic Acid)

Examples of the polyvalent carboxylic acid include a dicarboxylic acid. This dicarboxylic acid may be one or more, is preferably an aliphatic dicarboxylic acid, and may further contain an aromatic dicarboxylic acid. The aliphatic dicarboxylic acid is preferably a straight-chain type from the viewpoint of enhancing the crystallinity of the crystalline polyester resin.

(Aliphatic Dicarboxylic Acid)

Examples of the aliphatic dicarboxylic acid include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicathoxylic acid (dodecanedioic acid), 1,13-tridecanedicarboxylic acid, 1,14-tetradecanedicarboxylic acid, 1,16-hexadecanedicaboxylic acid, 1,18-octadecanedicarboxylic acid, and lower alkyl esters thereof and anhydrides thereof. Among others, an aliphatic dicarboxylic acid having 6 to 16 carbon atoms is preferable, more preferably an aliphatic dicarboxylic acid having 10 to 14 carbon atoms from the viewpoint of easily obtaining an effect of compatibility between low-temperature fixability and transfer performance.

(Aromatic Dicarboxylic Acid)

Examples of the aromatic dicarboxylic acid include terephthalic acid, isophthalic acid, orthophthalic acid, t-butylisophthalic acid, 2,6-naphthalenedicarboxylic acid, and 4,4′-biphenyldicarboxylic acid. Among others, terephthalic acid, isophthalic acid, or t-butylisophthalic acid is preferable from the viewpoint of easiness of availability and easiness of emulsification.

(Preferred Content of Dicarboxylic Acid in Crystalline Polyester Resin)

The content of the constituent unit derived from the aliphatic dicarboxylic acid to the constituent unit derived from the dicarboxylic acid in the crystalline polyester resin is preferably 50 mol % or more, more preferably 70 mol % or more, still more preferably 80 mol % or more, and particularly preferably 100 mol % from the viewpoint of sufficiently securing the crystallinity of the crystalline polyester resin.

(Diol)

Examples of the polyhydric alcohol component include a diol. The diol may be one or more, is preferably an aliphatic diol, and may further contain a diol other than the aliphatic diol. The aliphatic diol is preferably a straight-chain type from the viewpoint of enhancing the crystallinity of the crystalline polyester resin.

(Aliphatic Diol)

Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among others, an aliphatic diol having 2 to 120 carbon atoms is preferable, more preferably an aliphatic diol having 4 to 6 carbon atoms from the viewpoint of easily obtaining an effect of compatibility between low-temperature fixability and transfer performance.

(Additional Diol)

Examples of an additional diol include a diol having a double bond and a diol having a sulfonate group. Specifically, examples of the diol having a double bond include 2-butene-1,4-diol, 3-hexnene-1,6-diol, and 4-octene-1,8-diol.

(Preferred Content of Aliphatic Diol in Crystalline Polyester Resin)

The content of the constituent unit derived from the aliphatic diol to the constituent unit derived from the diol in the crystalline polyester resin is preferably 50 mol % or more, more preferably 70 mol % or more, still more preferably 80 mol % or more, and particularly preferably 100 mol % from the viewpoint of the low-temperature fixability of the toners and of enhancing the glossiness of an image to be finally formed.

(Preferred Ratio of Diol to Dicarboxylic Acid)

The ratio of the diol to the dicarboxylic acid in the monomer for the crystalline polyester resin is preferably in the range of 2.0/1.0 to 1.0/2.0, more preferably in the range of 1.5/1.0 to 1.0/1.5, and particularly preferably in the range of 1.3/1.0 to 1.0/1.3 in terms of an equivalent ratio of a hydroxy group [OH] of the diol to a carboxy group [COOH] of the dicarboxylic acid, [OH]/[COOH].

(Synthesis of Crystalline Polyester Resin)

The crystalline polyester resin can be synthesized by subjecting the polyvalent carboxylic acid and the polyhydric alcohol to polycondensation (esterification) utilizing a known esterification catalyst.

(Catalyst Usable for Synthesizing Crystalline Polyester Resin)

The catalyst usable for synthesizing the crystalline polyester resin may be one or more, and examples thereof include: a compound of an alkali metal, such as sodium or lithium; a compound containing a group II element, such as magnesium or calcium; a compound of a metal, such as aluminum, zinc, manganese, antimony, titanium, tin, zirconium, or germanium; a phosphorous acid compound; a phosphoric acid compound; and an amine compound.

Specifically, examples of the tin compound include dibutyltin oxide, tin octylate, tin dioctylate, and salts thereof. Examples of the titanium compound include: titanium alkoxides, such as tetra-normal-butyl titanate, tetra-isopropyl titanate, tetra-methyl titanate, and tetra-stearyl titanate; titanium acylates, such as polyhydroxy titanium stearate; and titanium chelates, such as titanium tetra-acetylacetonate, titanium lactate, and titanium triethanolaminate Examples of the germanium compound include germanium dioxide, and examples of the aluminum compound include: oxides, such as polyaluminum hydroxide; aluminum alkoxides, and tributyl aluminate

(Preferred Polymerization Temperature for Crystalline Polyester Resin)

The polymerization temperature for the crystalline polyester resin is preferably in the range of 150 to 250° C. Moreover, the polymerization time is preferably in the range of 0.5 to 10 hours. The pressure in the reaction system may be reduced as necessary during polymerization.

<Hybrid Crystalline Polyester Resin>

A hybrid crystalline polyester resin (hereinafter, also simply referred to as “hybrid resin”) may be contained as the crystalline polyester resin. When the hybrid crystalline resin is contained, the affinity with the amorphous resin which is used together with the crystalline resin is thereby enhanced, and therefore the low-temperature fixability of the toners is improved. Moreover, the dispersibility of the crystalline resin in the toners is improved, and therefore bleed-out can be suppressed.

The hybrid resin may be one or more. Moreover, the hybrid resin may be replaced with the whole amount of the crystalline polyester resin, may be replaced with part of the crystalline polyester resin, or may be used together with the crystalline polyester resin.

The hybrid resin is a resin in which a crystalline polyester polymer segment and an amorphous polymer segment are chemically bonded. The crystalline polyester polymer segment means a part derived from the crystalline polyester resin. That is, the crystalline polyester polymer segment means a molecular chain having the same chemical structure as the molecular chain that constitutes the abovementioned crystalline polyester resin. Moreover, the amorphous polymer segment means a part derived from the amorphous resin. That is, the amorphous polymer segment means a molecular chain having the same chemical structure as the molecular chain that constitutes the abovementioned amorphous resin.

(Preferred Weight Average Molecular Weight (Mw) of Hybrid Resin)

A preferred weight average molecular weight (Mw) of the hybrid resin is preferably in the range of 5000 to 100000, more preferably in the range of 7000 to 50000, and particularly preferably in the range of 8000 to 20000 from the viewpoint that compatibility between sufficient low-temperature fixability and excellent long-term storage stability can surely be achieved. When Mw of the hybrid resin is set to 100000 or less, sufficient low-temperature fixability can thereby be obtained. On the other hand, when Mw of the hybrid resin is set to 5000 or more, excessive progress of compatibilization between the hybrid resin and the amorphous resin during storage of the toners is thereby suppressed, so that an image failure due to fusion bonding among toners can effectively be suppressed.

(Crystalline Polyester Polymer Segment)

The crystalline polyester polymer segment may be, for example, a resin having a structure in which an additional component is copolymerized with a main chain formed with a crystalline polyester polymer segment, or may be a resin having a structure in which a crystalline polyester polymer segment is copolymerized with a main chain composed of an additional component. The crystalline polyester polymer segment can be synthesized from the abovementioned polyvalent carboxylic acid and polyhydric alcohol in the same manner as the abovementioned crystalline polyester resin.

(Content of Crystalline Polyester Polymer Segment in Hybrid Resin)

The content of the crystalline polyester polymer segment in the hybrid resin is preferably in the range of 80 to 98% by mass, more preferably in the range of 90 to 95% by mass, and still more preferably in the range of 91 to 93% by mass from the viewpoint of imparting sufficient crystallinity to the hybrid resin. It is to be noted that the constituents of each polymer segment in the hybrid resin (or in the toners) and the contents thereof can be specified by utilizing a known analysis method, such as, for example, nuclear magnetic resonance (NMR) or methylation reaction pyrolytic gas chromatography/mass spectrometry (Py-GC/MS).

(Preferred Aspect of Crystalline Polyester Polymer Segment)

The monomer for the crystalline polyester polymer segment preferably further contains a monomer having an unsaturated bond from the viewpoint of introducing a chemical bonding site with the amorphous polymer segment into the crystalline polyester polymer segment. The monomer having an unsaturated bond is, for example, a polyhydric alcohol having a double bond, and examples thereof include: polyvalent carboxylic acids having a double bond, such as methylene succinic acid, fumaric acid, maleic acid, 3-hexanedioic acid, and 3-octenedioic acid; 2-butene-1,4-diol, 3-hexene-1,6-diol, and 4-octene-1,8-diol. The content of the constituent unit derived from the monomer having an unsaturated bond in the crystalline polyester polymer segment is preferably in the range of 0.5 to 20% by mass.

The hybrid resin may be a block copolymer or a graft copolymer, and is preferably a graft copolymer from the viewpoint of making orientation of the crystalline polyester polymer segment easily controllable and imparting sufficient crystallinity to the hybrid resin, and the crystalline polyester polymer segment is more preferably grafted using the amorphous polymer segment as the main chain. That is, the hybrid resin is preferably a graft copolymer having the amorphous polymer segment as the main chain and the crystalline polyester polymer segment as a side chain.

(Introduction of Functional Group)

Further, a functional group, such as a sulfonate group, a carboxy group, or a urethane group, may be introduced in the hybrid resin. The introduction of the functional group may be into the crystalline polyester polymer segment or into the amorphous polymer segment.

(Amorphous Polymer Segment)

The amorphous polymer segment enhances the affinity between the amorphous resin and the hybrid resin that constitute the binder resin. Thereby, the hybrid resin is easily incorporated into the amorphous resin, so that the charge uniformity of the toners is further improved. The constituents of the amorphous polymer segment in the hybrid resin (or in the toners) and the contents thereof can be specified by utilizing a known analysis method, such as, for example, NMR or methylation reaction Py-GC/MS.

Moreover, the amorphous polymer segment as well as the amorphous resin according to the present invention preferably has a glass transition temperature (Tg₁) in the range of 30 to 80° C., more preferably in the range of 40 to 65° C. in the first temperature increasing process in DSC. It is to be noted that the glass transition temperature (Tg₁) can be measured by a known method (for example, DSC).

(Preferred Aspect of Amorphous Polymer Segment)

The amorphous polymer segment is preferably constituted by a resin of the same type as the amorphous resin contained in the binder resin from the viewpoint of enhancing the affinity with the binder resin and enhancing the charge uniformity of the toners. When such an embodiment is taken, the affinity between the hybrid resin and the amorphous resin is thereby improved more, and “resins of the same type” mean resins each having a .characteristic chemical bond in the repeating unit.

The “characteristic chemical bond” follows the “Polymer Classification” described in Materials Database of National Institute for Material Science (NIMS) (http://polymernims go.jp/PoLyInfo/guide/jp/term_polymer.html). That is, a chemical bond that constitutes a polymer classified by a total of 22 types of polymers which are polyacrylic, polyamide, polyacid anhydride, polycarbonate, polydiene, polyester, polyhaloolefin, polyimide, polyimine, polyketone, polyolefin, polyether, polyphenylene, polyphosphazene, polysiloxane, polystyrene, polysulfide, polysulfone, polyurethane, polyurea, polyvinyl, and other polymers, is referred to as the “characteristic ;chemical bond”.

Moreover, the “resins of the same type” in the case where the resins are copolymers mean resins each having a characteristic chemical bond in common when a monomer species having the chemical bond is used as a constituent unit in chemical structures of a plurality of monomer species that constitute the copolymers. Accordingly, even when a property which each resin itself exhibits is different from each other or even when a molar component ratio of the monomer species that constitute each copolymer is different from each other, the resins are regarded as the resins of the same type as long as the resins have a characteristic chemical bond in common.

For example, a resin (or polymer segment) which is formed with styrene, butyl acrylate, and acrylic acid and a resin (or polymer segment) which is formed with styrene, butyl acrylate, and methacrylic acid have at least a chemical bond that constitutes polyacrylic, and therefore these are the resins of the same type. As another example, a resin (or polymer segment) which is formed with styrene, butyl acrylate, and acrylic acid and a resin (or polymer segment) which is formed with styrene, butyl acrylate, acrylic acid, terephthalic acid, and fumaric acid have at least a chemical bond that constitutes polyacrylic as a chemical bond in common. Accordingly, these are the resins of the same type.

Examples of the amorphous polymer segment include a vinyl polymer segment, a urethane polymer segment, and a urea polymer segment. Among others, the amorphous polymer segment is preferably a vinyl polymer segment from the viewpoint of easily controlling thermoplasticity. The vinyl polymer segment can be synthesized in the same manner as the vinyl resin according to the present invention.

(Preferred Content of Constituent Unit Derived from Styrene Monomer)

The content of the constituent unit derived from the styrene monomer in the amorphous polymer segment is preferably in the range of 40 to 90% by mass from the viewpoint of making it easy to control the plasticity of the hybrid resin. Moreover, from the same viewpoint, the content of the constituent unit derived from the (meth)acrylic acid ester monomer in the amorphous polymer segment is preferably in the range of 10 to 60% by mass.

(Preferred Content of Amphoteric Compound)

Further, the amorphous polymer segment preferably further contains the abovementioned amphoteric compound as the monomer from the viewpoint of introducing a chemical bonding site with crystalline polyester polymer segment into the amorphous polymer segment. The content of the constituent unit derived from the amphoteric compound in the amorphous polymer segment is preferably in the range of 0.5 to 20% by mass.

(Preferred Content of Amorphous Polymer Segment in Hybrid Resin)

The content of the amorphous polymer segment in the hybrid resin is preferably in the range of 3 to 15% by mass, more preferably in the range of 5 to 10% by mass, and still more preferably in the range of 7 to 9% by mass from the viewpoint of imparting sufficient crystallinity to the hybrid resin.

(Method for Producing Hybrid Resin)

The hybrid resin can be produced by, for example, any one of the first to third production methods described below.

(First Production Method)

The first production method is a method for producing the hybrid resin by performing a polymerization reaction that synthesizes the crystalline polyester polymer segment in the presence of the amorphous polymer segment synthesized in advance.

In this method, the amorphous polymer segment is first synthesized by subjecting the abovementioned monomer (preferably, a vinyl monomer such as a styrene monomer or a (meth)acrylic acid ester monomer) that constitutes the amorphous polymer segment to an addition reaction. Subsequently, the crystalline polyester polymer segment is synthesized by subjecting a polyvalent carboxylic acid and a polyhydric alcohol to a polymerization reaction in the presence of the amorphous polymer segment. On this occasion, the hybrid resin is synthesized by subjecting the polyvalent carboxylic acid and the polyhydric alcohol to a condensation reaction and subjecting the polyvalent carboxylic acid or the polyhydric alcohol to an addition reaction to the amorphous polymer segment.

In the first method, a site where these polymer segments can react with each other is preferably incorporated in the crystalline polyester polymer segment or the amorphous polymer segment. Specifically, the abovementioned amphoteric compound is also used in addition to the monomer that constitutes the amorphous polymer segment when the amorphous polymer segment is synthesized. When the amphoteric compound reacts with a carboxy group or a hydroxy group in the crystalline polyester polymer segment, the crystalline polyester polymer segment is thereby bonded to the amorphous polymer segment chemically and quantitatively. Moreover, when the crystalline polyester polymer segment is synthesized, the abovementioned compound having an unsaturated bond may further be contained in the monomer for synthesizing the crystalline polyester polymer segment.

The hybrid resin having a structure (graft structure) in which the crystalline polyester polymer segment is bonded to the amorphous polymer segment to form a molecular bond can be synthesized by the first method.

(Second Production Method)

The second production method is a method for producing the hybrid resin by forming the crystalline polyester polymer segment and the amorphous polymer segment separately in advance and bonding these segments.

In this method, the crystalline polyester polymer segment is first synthesized by subjecting a polyvalent carboxylic acid and a polyhydric alcohol to a condensation reaction. Moreover, the amorphous polymer segment is synthesized by subjecting the abovementioned monomer that constitutes the amorphous polymer segment to addition polymerization separately from the reaction system that synthesizes the crystalline polyester polymer segment. On this occasion, a site where the crystalline polyester polymer segment and the amorphous polymer segment can react with each other is preferably incorporated in one or both of the crystalline polyester polymer segment and the amorphous polymer segment in a manner as mentioned above.

Subsequently, the synthesized crystalline polyester polymer segment and amorphous polymer segment are reacted, and the hybrid resin having a structure in which the crystalline polyester polymer segment and the amorphous polymer segment are bonded to form a molecular bond can thereby be synthesized.

Moreover, when the site where the reaction can occur is incorporated neither in the crystalline polyester polymer segment nor in the amorphous polymer segment, a method of putting a compound having a site which can be bonded to both of the crystalline polyester polymer segment and the amorphous polymer segment in a system where the crystalline polyester polymer segment and the amorphous polymer segment coexist may be adopted. Thereby, the hybrid resin having a structure in which the crystalline polyester polymer segment and the amorphous polymer segment are bonded through the compound to form a molecular bond through the compound can be synthesized.

(Third Production Method)

The third production method is a method for producing the hybrid resin by performing a polymerization reaction that synthesizes the amorphous polymer segment in the presence of the crystalline polyester polymer segment.

In this method, polymerization is first performed to synthesize the crystalline polyester polymer segment in advance by subjecting a polyvalent carboxylic acid and a polyhydric alcohol to a condensation reaction. Subsequently, the amorphous polymer segment is synthesized by subjecting a monomer that constitutes the amorphous polymer segment to a polymerization reaction in the presence of the crystalline polyester polymer segment. On this occasion, a site where these polymer segments can react with each other is preferably incorporated in the crystalline polyester polymer segment or the amorphous polymer segment in the same manner as in the first production method.

The hybrid resin having a structure (graft structure) in which the amorphous polymer segment is bonded to the crystalline polyester polymer segment to form a molecular bond can be synthesized by the abovementioned method.

Among the first to third production methods, the first production method is preferable because the hybrid resin having a structure in which a crystalline polyester resin chain is grafted onto an amorphous resin chain is easily synthesized, and the production steps can be simplified. In the first production method, the amorphous polymer segment is formed in advance, and thereafter the crystalline polyester polymer segment is bonded thereto, and therefore the orientation of the crystalline polyester polymer segment easily becomes uniform.

[1.2] Colorant

In the electrostatic latent image developing toners according to the present invention, various types and various colors of organic or inorganic pigments given below as examples can be used as a colorant, and two or more colorants may be combined and used as necessary for every color.

Specifically, carbon black, a magnetic substance, iron/titanium composite oxide black, or the like can be used as a colorant for the black toner. Examples of carbon black include channel black, furnace black, acetylene black, thermal black, and lamp black, and examples of the magnetic substance include ferrite and magnetite.

Examples of the colorant for the yellow toner include dyes such as C.I. Solvent Yellow 2, 6, 14, 15, 16, 19, 21, 33, 44, 56, 61, 77, 79, 80, 81, 82, 93, 98, 103, 104, 112, and 162, and pigments such as C.I. Pigment Yellow 1, 3, 5, 11, 12, 13, 14, 15, 17, 62, 65, 73, 74, 81, 83, 93, 94, 97, 138, 139, 147, 150, 151, 154, 155, 162, 168, 174, 176, 180, 183, 185, and 191, and mixtures thereof can also be used.

Examples of the colorant for the magenta toner include dyes such as Solvent Red 1, 49, 52, 58, 63, 111, and 122, and pigments such as C.I. Pigment Red 2, 3, 4, 5, 6, 7, 8, 13, 15, 16, 21, 22, 23, 31, 48:1, 48:2, 48:3, 48:4, 49:1, 53:1, 57:1, 60, 63, 63:1, 64, 68, 81, 83, 87, 88, 89, 90, 112, 114, 122, 123, 139, 144, 146, 149, 150, 163, 166, 169, 170, 175, 176, 177, 178, 184, 185, 188, 202, 206, 207, 208, 209, 210, 222, 238, 254, 255, 266, 268, and 269, and mixtures thereof can also be used.

Examples of the colorant for the cyan toner include dyes such as C.I. Solvent Blue 25, 36, 60, 70, 93 and 95, and pigments such as C.I. Pigment Blue 2, 3, 15, 15:2, 15:3, 15:4, 16, 17, 60, 62, and 66, and mixtures thereof can also be used.

The content of the colorant is preferably 1 to 30% by mass, more preferably 2 to 20% by mass in the toners.

The number average primary particle diameter of the colorant is not particularly limited, and is preferably about 10 to 200 nm in general.

Moreover, a surface-modified colorant can also be used as the colorant. As a surface-modifier, a conventionally known surface-modifier can be used, and specifically, a silane coupling agent, a titanium coupling agent, an aluminum coupling agent, and the like can be used.

[1.3] Release Agent

The electrostatic latent image developing toners according to the present invention each contains a release agent. The melting point of the release agent is preferably in the range of 70 to 95° C., more preferably in the range of 75 to 95° C. It is to be noted that the melting point of the release agent can be measured by the same method as the melting point of the binder resin.

The release agent is not particularly limited, and various known waxes are used. As a specific example thereof, for example, a polyolefin wax, such as a polyethylene wax or a polypropylene wax; a branched-chain hydrocarbon wax, such as a microcrystalline wax; a long-chain hydrocarbon-based wax, such as a paraffin wax or a Sasol wax; a dialkyl ketone-based wax, such as distrearyl ketone; an ester-based wax, such as a carnauba wax, a montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate, or distearyl maleate; or an amide-based wax, such as ethylenediamine behenyl amide or tristearylamide trimellitate can be used.

The release agent that is usable in the present invention will be described in more detail.

The ester wax that can be used as a release agent contains at least an ester.

As the ester, any of a monoester, a diester, a triester, and a tetraester can be used, and examples thereof include: an ester of a higher fatty acid and a higher alcohol, the ester having any one of structures represented by the following formulas (1) to (3); a trimethylolpropane triester having a structure represented by the following formula (4); a glycerin triester having a structure represented by the following formula (5); and a pentaerythritol tetraester having a structure represented by the following formula (6).

R¹—COO—R² Formula (1)

R¹—COO—(CH₂)ₙ—OCO—R² Formula (2)

R¹—OCO—(CH₂)ₙ—COO—R² Formula (3)

In formulas (1) to (3), R¹ and R² each independently represent a substituted or unsubstituted hydrocarbon group having 13 to 30 carbon atoms. R¹ and R² may be the same or different. n represents an integer of 1 to 30.

R¹ and R² each represent a hydrocarbon group having 13 to 30 carbon atoms, and are each preferably a hydrocarbon group having 17 to 22 carbon atoms.

n represents an integer of 1 to 30, and preferably represents an integer of 1 to 12.

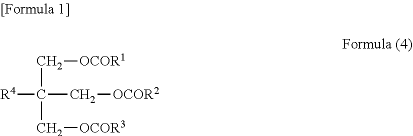

In formula (4), R¹ to R⁴ each independently represent a substituted or unsubstituted hydrocarbon group having 13 to 30 carbon atoms. R¹ to R⁴ may be the same or different. It is to be noted that R¹ to R⁴ are each preferably a hydrocarbon group having 17 to 22 carbon atoms.

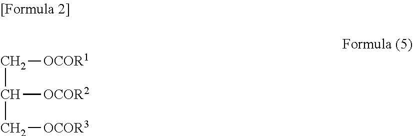

In formula (5), R¹ to R³ each represent a substituted or unsubstituted hydrocarbon group having 13 to 30 carbon atoms. R¹ to R³ may be the same or different. It is to be noted that R¹ to R³ are each preferably a hydrocarbon group having 17 to 22 carbon atoms.

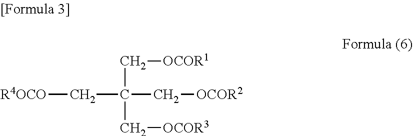

In formula (6), R¹ to R⁴ each independently represent a substituted or unsubstituted hydrocarbon group having 13 to 30 carbon atoms. R¹ to R⁴ may be the same or different. R¹ to R⁴ are each preferably a hydrocarbon group having 17 to 22 carbon atoms.

The substituent which R¹ to R⁴ may have is not particularly limited in a range where the effects of the present invention are not inhibited, and examples thereof include a straight-chain or branched alkyl group, an alkenyl group, an alkynyl group, an aromatic hydrocarbon ring group, an aromatic heterocycle group, a non-aromatic hydrocarbon ring group, a non-aromatic heterocycle group, an alkoxy group, a cycloalkoxy group, an aryloxy group, an alkylthio group, a cycloalkylthio group, an arylthio group, an alkoxycarbonyl group, an aryloxycarbonyl group, a sulfamoyl group, an acyl group, an acyloxy group, an amide group, a carbamoyl group, a ureido group, a sulfinyl group, an alkylsulfonyl group, an arylsulfonyl group or a heteroarylsulfonyl group, an amino group, a halogen atom, a fluorohydrocarbon group, a cyano group, a nitro group, a hydroxy group, a thiol group, a silyl group, and a deuterium atom.

Specific examples of the monoester having a structure represented by the formula (1) include a compound having any one of structures represented by the following formulas (1-1) to (1-8).

CH₃—(CH₂)₁₂—COO—(CH₂)₁₃—CH₃ Formula (1-1)

CH₃—(CH₂)₁₄—COO—(CH₂)₁₅—CH₃ Formula (1-2)

CH₃—(CH₂)₁₆—COO—(CH₂)₁₇—CH₃ Formula (1-3)

CH₃—(CH₂)₁₆—COO—(CH₂)₂₁—CH₃ Formula (1-4)

CH₃—(CH₂)₂₀—COO—(CH₂)₁₇—CH₃ Formula (1-5)

CH₃—(CH₂)₂₀—COO—(CH₂)₂₁—CH₃ Formula (1-6)

CH₃—(CH₂)₂₅—COO—(CH₂)₂₅—CH₃ Formula (1-7)

CH₃—(CH₂)₂₈—COO—(CH₂)₂₉—CH₃ Formula (1-8)

Specific examples of the diester having any one of structures represented by the formula (2) and the formula (3) include a compound having any one of structures represented by the following formulas (2-1) to (2-7) and (3-1) to (3-3).

CH₃—(CH₂)₂₀—COO—(CH₂)₄—OCO—(CH₂)₂₀—CH₃ Formula (2-1)

CH₃—(CH₂)₁₈—COO—(CH₂)₄—OCO—(CH₂)₁₈—CH₃ Formula (2-2)

CH₃—(CH₂)₂₀—COO—(CH₂)₂—OCO—(CH₂)₂₀—CH₃ Formula (2-3)

CH₃—(CH₂)₂₂—COO—(CH₂)₂—OCO—(CH₂)₂₂—CH₃ Formula (2-4)

CH₃—(CH₂)₁₆—COO—(CH₂)₄—OCO—(CH₂)₁₆—CH₃ Formula (2-5)

CH₃—(CH₂)₂₆—COO—(CH₂)₂—OCO—(CH₂)₂₆—CH₃ Formula (2-6)

CH₃—(CH₂)₂₀—COO—(CH₂)₆—OCO—(CH₂)₂₀—CH₃ Formula (2-7)

CH₃—(CH₂)₂₁—OCO—(CH₂)₆—COO—(CH₂)₂₁—CH₃ Formula (3-1)

CH₃—(CH₂)₂₃—OCO—(CH₂)₆—COO—(CH₂)₂₃—CH₃ Formula (3-2)

CH₃—(CH₂)₁₉—OCO—(CH₂)₆—COO—(CH₂)₁₉—CH₃ Formula (3-3)

Specific examples of the triester having a structure represented by the formula (4) include a compound having any one of structures represented by the following formulas (4-1) to (4-6).

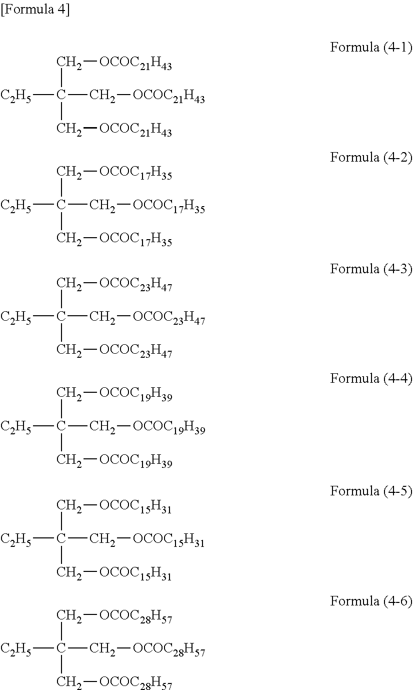

Specific examples of the triester having a structure represented by the formula (5) include a compound having any one of structures represented by the following formulas (5-1) to (5-6).

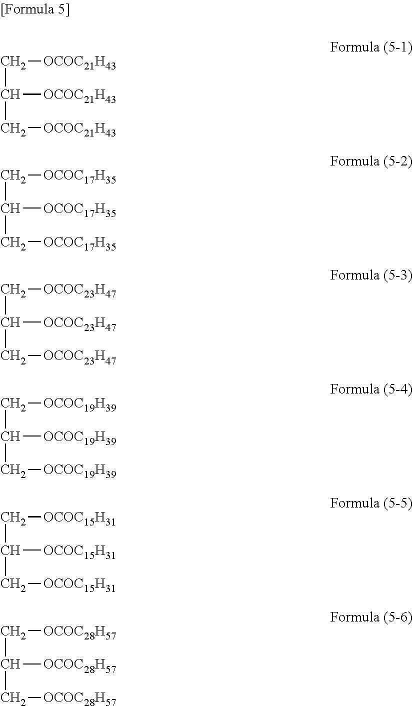

Specific examples of the tetraester having a structure represented by the formula (6) include a compound having any one of structures represented by the following formulas (6-1) to (6-5).

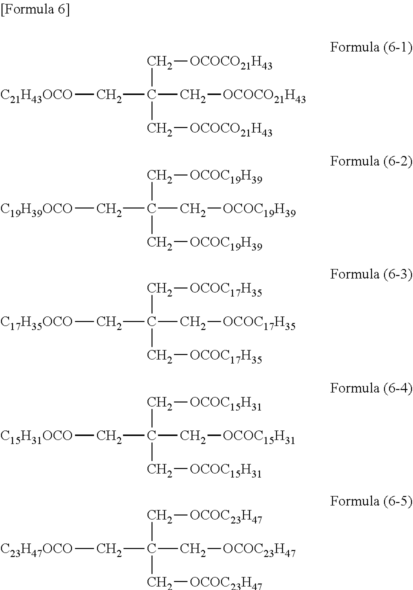

Among the above compounds, the ester is preferably a monoester.

Moreover, the ester wax that can be adopted as a release agent may be an ester wax having a structure in which a plurality of structures among a monoester structure, a diester structure, a triester structure, and a tetraester structure are included in one molecule.

Moreover, two or more of the above esters can be combined and used as a release agent.

(Microcrystalline Wax)

As mentioned above, the microcrystalline wax may also be used as the release agent according to the present invention.

The microcrystalline wax herein is different from a paraffin wax whose main component is a straight-chain hydrocarbon (normal paraffin) and refers to a wax containing a large amount of a branched-chain hydrocarbon (isoparaffin) and a cyclic hydrocarbon (cycloparaffin) in addition to a straight-chain hydrocarbon among petroleum waxes, and the microcrystalline wax generally has a smaller crystal and a larger molecular weight than a paraffin wax because large amounts of low-crystalline isoparaffin and cycloparaffin are contained therein.

Such a microcrystalline wax has 30 to 60 carbon atoms, a weight average molecular weight in the range of 500 to 800, and a melting point in the range of 60 to 90° C. As the microcrystalline wax, a microcrystalline wax having a weight average molecular weight in the range of 600 to 800 and a melting point in the range of 60 to 85° C. is preferable. Moreover, a microcrystalline wax having a low molecular weight, especially a microcrystalline wax having a number average molecular weight in the range of 300 to 1000, is preferable, more preferably in the range of 400 to 800. Moreover, the ratio of the weight average molecular weight to the number average molecular weight (Mw/Mn) is preferably in the range of 1.01 to 1.20.

Examples of the microcrystalline wax include microcrystalline waxes such as HNP-0190, Hi-Mic-1045, Hi-Mic-1070, Hi-Mic-1080, Hi-Mic-1090, Hi-Mic-2045, Hi-Mic-2065, and Hi-Mic-2095, and waxes EMW-0001 and EMW-0003 each containing isoparaffin as a main component, all manufactured by Nippon Seiro Co., Ltd.

The existence or nonexistence of a branch and the percentage of the branch in the microcrystalline wax can specifically be calculated by the following expression (i) from a spectrum which is obtained by ¹³C-NMR measurement method under the following condition.

Percentage of branch (%)=(C3+C4)/(C1+C2+C3+C4)×100 Expression (i):

(in expression (i), C1 represents a peak area of primary carbon atoms, C2 represents a peak area of secondary carbon atoms, C3 represents a peak area of tertiary carbon atoms, and C4 represents a peak area of quaternary carbon atoms.)

(Condition in ¹³C-NMR Measurement Method)
Measurement apparatus: FT NMR apparatus Lambda 400 (manufactured by JEOL Ltd.)
Measurement frequency: 100.5 MHz
Pulse condition: 4.0 μs
Data points: 32768
Delay time: 1.8 sec
Frequency range: 27100 Hz
Cumulative number: 20000
Measurement temperature: 80° C.
Solvent: Bezene-d₆/o-dichlorobenzene-d₄32 1/4 (v/v)
Sample concentration: 3% by mass
Sample tube: Diameter of 5 mm
Measurement mode: ¹H Complete decoupling method

(Types/Combination of Preferred Release Agents)

Among the release agents given as examples, the release agent in the present invention preferably contains at least a fatty acid ester wax having 30 to 72 carbon atoms. This makes it easy to set the crystallization temperature to a preferred range (50 to 80° C.) and can make the low-temperature fixability satisfactory. It is to be noted that specific examples of such a fatty acid ester wax include, but not limited to, behenyl behenate, stearyl behenate, stearyl stearate, a tetrabehenic acid ester of pentaerythritol, a tetrastearic acid ester of pentaerythritol, and a behenic acid ester of glycerin.

Moreover, the release agent preferably contains a hydrocarbon wax and, among others, is preferably a hydrocarbon wax having a branched structure. This is because the branched structure makes it easy to facilitate crystallization, and as a result, ΔH_{c}(L) can be made suitably small, so that the effects of the present invention can suitably be exhibited. It is to be noted that specific examples of such a hydrocarbon wax having a branched structure include, but not limited to, Microcrystalline HNP0190.

Further, the release agent more preferably contains at least a hydrocarbon wax and a fatty acid ester wax having of 30 to 72 carbon atoms. This allows the crystallization temperature to fall within a more preferred range and can make the low-temperature fixability more satisfactory. Moreover, when the release agent contains at least a hydrocarbon wax and a fatty acid ester wax having 30 to 72 carbon atoms, the hydrocarbon wax having a high crystallization temperature is thereby mixed with the fatty acid ester having a low crystallization temperature. Further, the crystallization of the fatty acid ester is facilitated and ΔH_{C}(L) can suitably be made small, so that the effects of the present invention can suitably be exhibited.

The content of the release agent is preferably 0.1 to 30% by mass, more preferably 1 to 15% by mass in the toners. The amount of the release agent to be added is preferably 0.1% by mass or more in terms of suppression of an image defect due to separation failure between a fixing member and an image. Moreover, the amount of the release agent to be added is preferably 30% by mass or less in that satisfactory image quality can be obtained.

[1.4] Additional Additive

[Charge Controlling Agent]

Examples of the charge controlling agent include a nigrosine-based dye, a metal salt of naphthenic acid or a higher fatty acid, an alkoxylated amine, a quaternary ammonium salt compound, an azo-based metal chelate, and a metal salt of salicylic acid or a metal chelate of salicylic acid. The charge controlling agent may be one or more.

[Surfactant]

Examples of the surfactant include: anionic surfactants, such as sulfuric ester salt-based, sulfonate-based, and phosphoric acid ester-based surfactants; cationic surfactants, such as amine salt type and quaternary ammonium salt type surfactants; and nonionic surfactants, such as polyethylene glycol-based, alkyl phenol ethylene oxide adduct-based, and polyhydric alcohol-based surfactants. The surfactant may be one or more.

Specific examples of the anionic surfactants include sodium dodecylbenzenesulfonate, sodium dodecylsulfonate, a sodium alkylnaphthalenesulfonate, and a sodium dialkylsulfosuccinate. Specific examples of the cationic surfactants include an alkylbenzene dimethyl ammonium chloride, an alkyl trimethyl ammonium chloride, and distearyl ammonium chloride. Examples of the nonionic surfactants include a polyoxyethylene alkyl ether, a glycerin fatty acid ester, a sorbitan fatty acid ester, a polyoxyethylene sorbitan fatty acid ester, and a polyoxyethylene fatty acid ester.

[1.5] External Additive

An external additive, such as a superplasticizer or a cleaning assistant, which is a so-called post-processing agent, is added to the surface of the toner matrix particle in order to improve the fluidity, electrification properties, cleaning properties, or the like of the toners.

The external additive according to the present invention may be one or more. The external additive is not particularly limited, a known external additive can be used, and, for example, a silica particle, a titania particle, an alumina particle, a zirconia particle, a zinc oxide particle, a chromium oxide particle, a cerium oxide particle, an antimony oxide particle, a tungsten oxide particle, a tin oxide particle, a tellurium oxide particle, a manganese oxide particle, and a boron oxide particle can be used.

The external additive more preferably contains a silica particle prepared by a sol-gel method. The silica particle prepared by a sol-gel method has a characteristic that the particle diameter distribution is narrow, and is therefore preferable from the viewpoint of suppressing variation in adhesion strength of the external additive to the toner matrix particle.

Moreover, the number average primary particle diameter of the silica particle is preferably 70 to 200 nm. The silica particle having a number average primary particle diameter in the range has a larger particle diameter as compared to the other external additives. Accordingly, such a silica particle has a role as a spacer in a two-component developing agent. Thus, such a silica particle is preferable from the viewpoint of preventing the other external additives which are smaller in size from being embedded in the toner matrix particle when the two-component developing agent is being stirred in a developing apparatus. Moreover, such a silica particle is also preferable from the viewpoint of preventing fusion bonding among toner matrix particles.

The number average primary particle diameter of the external additive can be determined by, for example, image processing of an image photographed by a transmission electron microscope, and can be adjusted by, for example, classification, or mixing of a classified product.

The surface of the external additive is preferably hydrophobization-processed. A known surface processing agent is used for the hydrophobization processing. The surface processing agent may be one or more, and examples thereof include a silane coupling agent, a silicone oil, a titanate-based coupling agent, an aluminate-based coupling agent, a fatty acid, a metal salt of a fatty acid or an esterified product thereof, and a rosin acid.

Examples of the silane coupling agent include dimethyldimethoxysilane, hexamethyldisilazane (HMDS), methyltrimethoxysilane, isobutyltrimethoxysilane, and decyltrimethoxysilane. Examples of the silicone oil include a cyclic compound and a straight-chain or branched organosiloxane, and more specifically include an organosiloxane oligomer, octamethylcyclotetrasiloxane, decamethylcyclopentasiloxane, tetramethylcyclotetrasiloxane, and tetravinyltetramethylcyclotetrasiloxane.

Moreover, examples of the silicone oil include a silicone oil having at least an end, which is highly reactive, having modified, the silicone oil having a modifying group introduced in a side chain, one end or both ends, a side chain and one end, a side chain and both ends, or the like. The type of the modifying group may be one or more, and examples thereof include alkoxy, carboxy, carbinol, higher fatty acid modification, phenol, epoxy, methacrylic, and amino.

The amount of the external additive to be added is preferably 0.1 to 10.0% by mass based on the total amount of the toner particle. The amount of the external additive to be added is more preferably 1.0 to 3.0% by mass.

[1.6] Physical Properties of Toner Particle

[Structure of Toner Particle]

The toner matrix particle according to the present invention may have a single-layered structure consisting of only a toner particle, and preferably has a core-shell structure. This can make the low-temperature fixability and heat-resistant storability more satisfactory.

The toner matrix particle having a core-shell structure refers to a toner matrix particle having a multi-layered structure provided with, as a core particle, the core particle, and a shell that covers the surface of the core particle. The shell does not have to cover the whole surface of the core particle and the core particle may be partially exposed. The section of the core-shell structure can be ascertained by known observation means, such as, for example, a transmission electron microscope (TEM) or a scanning probe microscope (SPM).

In the case of the core-shell structure, properties, such as a glass transition point, a melting point, and hardness, can be made different between the core particle and the shell, which enables the design of the toner particle according to the purpose. For example, a shell can be formed by aggregating and fusion-bonding a resin having a relatively high glass transition point onto the surface of a core particle which contains a binder resin, a colorant, a release agent, and the like, the core particle having a relatively low glass transition point. As mentioned above, the amorphous polyester resin can be used for the shell, and, among others, an amorphous polyester resin modified with a styrene/acrylic resin can preferably be used.

[Average Particle Diameter of Toner Particle]

The average particle diameter of the toner particle is preferably in the range of 3 to 15 μm, more preferably in the range of 4 to 8 μm, and still more preferably in the range of 4 to 7 μm in terms of a median diameter (d50) on a volume basis.

When the average particle diameter of the toner particle is in the range, high reproducibility is thereby obtained even for an extremely fine dot image of a 1200 dpi level.

It is to be noted that the average particle diameter of the toner particle can be controlled by the concentration of an aggregating agent which is used at the time of production; the amount of the organic solvent which is added at the time of production; the fusion-bonding time; the composition of the binder resin; and the like.

A measurement apparatus configured by connecting a computer system having a data processing software Software V3.51 installed therein to a Multisizer 3 (manufactured by Beckman Coulter, Inc.) can be used for the measurement of the median diameter (d50) of the toner particle on a volume basis.

Specifically, after a measurement sample (toner) is added to and mixed well with a surfactant solution (for example, a surfactant solution obtained by diluting a neutral detergent containing a surfactant component with pure water 10 times, the surfactant solution prepared for the purpose of dispersing a toner particle), ultrasonic dispersion is performed to prepare a toner particle dispersion liquid. This toner particle dispersion liquid is injected with a pipette into a beaker, in which ISOTON II (manufactured by Beckman Coulter, Inc.) is placed, in a sample stand, until the concentration displayed on the measurement apparatus becomes 8%. By setting the concentration to this concentration herein, measured values with reproducibility can be obtained. Subsequently, in the measurement apparatus, the number of counting the particles to be measured is set to 25000 particles and the aperture diameter is set to 100 μm, and a frequency value is calculated dividing a range of 2 to 60 μm, which is a measuring range, into 256 to obtain a particle diameter at 50% from a larger side in volume integrated fraction as a median diameter (d50) on a volume basis.

[Average Circularity of Toner Particle]

In the electrostatic latent image developing toners according to the present invention, the average circularity of the toner particle is preferably in the range of 0.930 to 1.000, more preferably in the range of 0.945 to 0.985. When the average circularity is in the range, crushing of the toner particles can be suppressed, so that contamination of a triboelectric charge imparting member is suppressed and the electrification properties of the toners can be stabilized. Moreover, images formed with the toners have high quality.

The average circularity can be measured as follows. A dispersion liquid of a toner is prepared in the same manner as in the case of measuring the median diameter. The dispersion liquid of the toner is photographed by FPIA-2100, FPIA-3000 (each manufactured by SYSMEX CORPORATION), or the like with a HPF (high power field) mode in a proper concentration range of 3000 to 10000 particles in terms of the number of particles detected in HPF to calculate the circularity for individual toner particles by the following expression (y). The circularity of each toner particle is added, and the average circularity is calculated by dividing the sum of the circularity by the number of the toner particles. When the number of particles detected in HPF is in the proper concentration range, sufficient reproducibility is obtained. In the following expression (y), L1 represents a circumferential length (μm) of a circle having the same projection area as a particle image, and L2 represents a circumferential length (μm) of a projection image of a particle.

Circularity=L1/L2 Expression (y)

[2] Method for Producing Toner Matrix Particle

When the electrostatic latent image developing toners according to the present invention are produced, the toner matrix particle can be produced by, for example, an emulsion aggregation method.

A production method in the case where the toner matrix particle according to the present invention is produced by an emulsion aggregation method includes, for example, preparing a mixed dispersion liquid by adding a dispersion liquid (a) containing a crystalline resin fine particle and a dispersion liquid (b) containing an amorphous resin fine particle to an aqueous medium, and forming the toner matrix particle by increasing the temperature of the mixed dispersion liquid to aggregate and fusion-bond the amorphous resin fine particle and the crystalline resin fine particle. It is to be noted that the “aqueous medium” in the present specification refers to an aqueous medium containing at least 50% by mass or more of water, and examples of a component other than water include an organic solvent that is soluble to water. Examples thereof include methanol, ethanol, isopropanol, butanol, acetone, methyl ethyl ketone, dimethylformamide, methyl cellosolve, and tetrahydrofuran. Among these, an alcohol-based organic solvent, such as methanol, ethanol, isopropanol, or butanol which is an organic solvent that does not dissolve a resin, is preferably used. Preferably, only water is used as the aqueous medium.

The constitution of the production method can be, for example, such that it includes the following steps. The following example herein describes a case where the crystalline resin fine particle is a crystalline polyester resin fine particle, and the toner matrix particle is a toner matrix particle containing a colorant, but the technical scope of the present invention is not limited to these embodiments.

(1) Preparing a colorant particle dispersion liquid containing a colorant particle dispersed therein,

(2) Preparing a dispersion liquid (a) by dissolving a crystalline polyester resin in an organic solvent to emulsify and disperse the crystalline polyester resin in an aqueous dispersion medium and removing the organic solvent, thereby preparing a dispersion liquid containing a crystalline polyester resin fine particle,

(3) Preparing a dispersion liquid (b) containing an amorphous resin fine particle containing a release agent,

(4) Preparing a mixed dispersion liquid by adding the respective dispersion liquids prepared in (1) to (3) to an aqueous medium,

(5) Forming aggregated particles by increasing a temperature of the mixed dispersion liquid prepared in (4) to aggregate the amorphous resin fine particle and the crystalline resin fine particle, thereby forming a toner matrix particle,

(6) Fusion-bonding the aggregated particles formed in (5) by thermal energy to control a shape, thereby obtaining the toner matrix particle,

(7) Cooling a dispersion liquid of the toner matrix particle,

(8) Performing filtrating/cleaning by filtrating and separating the toner matrix particle from the aqueous medium, thereby removing a surfactant and the like from the toner matrix particle, and

(9) Drying the cleaned toner matrix particle.

When the abovementioned steps are carried out, conventionally known knowledge can appropriately be referenced.

For example, the abovementioned dispersion liquid (a) containing a crystalline resin fine particle or dispersion liquid (b) containing an amorphous resin fine particle can be prepared using any of various emulsification methods, such as an emulsification method by mechanical shear force, and is preferably prepared using a method called a phase inversion emulsification method. Particularly with respect to the dispersion liquid (a), the use of the dispersion liquid (a) prepared by the phase inversion emulsification method can disperse oil droplets uniformly by changing the stability of a carboxy group of a polyester, and therefore the phase inversion emulsification method is excellent in that the oil droplets are not forcibly dispersed by shear force unlike the oil droplets dispersed by a mechanical emulsification method. By the “phase inversion emulsification method”, a dispersion liquid of a resin fine particle is obtained through: dissolving a resin in an organic solvent, thereby obtaining a resin solution; neutralization of putting a neutralizing agent into the resin solution; emulsification of emulsifying and dispersing the resin solution after the neutralization in an aqueous dispersion medium, thereby obtaining a resin-emulsified liquid; and desolventizing of removing the organic solvent from the resin-emulsified liquid.

It is to be noted that the particle diameter of the resin fine particle in the dispersion liquid can be controlled by changing the amount of the neutralizing agent to be added. The average particle diameter of the crystalline resin fine particle is preferably 100 to 300 nm as a median diameter on a volume basis. The method for measuring the average particle diameter is as described in Examples, which will be mentioned later.

Moreover, the toner matrix particle having a core-shell structure can also be made by utilizing the toner matrix particle as a core and providing a shell layer on the surface of the toner matrix particle. The heat-resistant storability and the low-temperature fixability can further be improved by making the core-shell structure.

To produce the toner matrix particle having a core-shell structure, the following step: for example, (5′) using the toner matrix particle prepared in (5) as a core particle, adding a dispersion liquid (c) for a shell to the mixed dispersion liquid, the dispersion liquid (c) containing an amorphous resin fine particle, thereby forming a shell on a surface of the core particle may be carried out after (5) forming aggregated particles, and subsequently, the steps of (6) or later may be carried out in the abovementioned production method.

[Preparing Colorant Particle Dispersion Liquid]

(Method for Preparing Pigment Particle Dispersion Liquid)

When a pigment particle is dispersed in an aqueous medium in the case where a pigment is used as a colorant, it is preferable that an aqueous medium dispersion liquid of the pigment particle be prepared to perform aggregation/fusion-bonding using the dispersion liquid and an aqueous medium dispersion liquid of a resin particle.

The aqueous medium which is used when the aqueous medium dispersion liquid of the pigment particle is prepared is as described above, and in this aqueous medium, a surfactant, a resin fine particle, or the like may be added for the purpose of improving dispersion stability.

Dispersion of the pigment particle can be performed utilizing mechanical energy, such a disperser is not particularly limited, examples of the disperser include, as given above, a low-speed shear disperser, a high-speed shear disperser, a friction disperser, a high-pressure jet disperser, an ultrasonic disperser, or high-pressure impact disperser Ultimizer, and specific examples of the disperser include HJP30006, manufactured by Sugino Machine, Ltd.

[Preparing Binder Resin Particle Dispersion Liquid Containing Release Agent]

As a method for preparing a binder resin particle dispersion liquid containing a release agent, an emulsion polymerization method or a mini-emulsion method is preferable.

For example, a polymerizable monomer that constitutes a binder resin and a release agent are mixed to prepare a mixed liquid, an aqueous medium in which a surfactant and a polymerization initiator are added is heated, and the mixed liquid is added into the heated aqueous medium. Subsequently, a resultant mixture is stirred mechanically to thereby perform mixing and dispersion, and the polymerizable monomer is subjected to emulsion polymerization, and a binder resin particle containing a release agent can thereby be obtained.

Further, a polymerizable monomer, or a mixed liquid of a polymerizable monomer and a release agent is added to the resultant binder resin particle containing a release agent to repeat polymerizing the polymerizable monomer as necessary, and the binder resin particle having a core-shell structure and containing a release agent can thereby be obtained.

Mixing of the polymerizable monomer into the aqueous medium and polymerization of the polymerizable monomer are preferably performed under stirring using mechanical energy in such a way as to make dispersion of the polymerizable monomer satisfactory and allow the polymerization to progress smoothly. Examples of such a device that imparts mechanical energy include dispersers such as a homogenizer, a low-speed shear disperser, a high-speed shear disperser, a friction disperser, a high-pressure jet disperser, an ultrasonic disperser, a high-pressure impact disperser, and Ultimizer.

Polymerization of the polymerizable monomer can be performed under any of normal pressure, reduced pressure, or pressurization, and is preferably performed under normal pressure (or in the vicinity of normal pressure, usually normal pressure ±10 mmHg). Moreover, the polymerization temperature is not particularly limited, and can appropriately be selected in a range where the polymerization of the polymerizable monomer progresses. The polymerization temperature is preferably, for example, 50° C. or higher and 150° C. or lower, more preferably 60° C. or higher and 130° C. or lower. Further, the polymerization time can also appropriately be selected in a range where the polymerization of the polymerizable monomer progresses, and is preferably, for example, 0.5 to 5 hours, more preferably 0.5 to 3 hours.

It is to be noted that the order of addition of the polymerizable monomer and the polymerization initiator into the aqueous medium is not particularly limited, and the order may be any of (1) a method of adding the polymerizable monomer (additive) after adding the polymerization initiator to the aqueous medium and (2) a method of adding the polymerization initiator after adding the polymerizable monomer (mixture) to the aqueous medium.

When the release agent is not contained in the first stage polymerization, (1) a method of adding the polymerizable monomer (mixture) after adding the polymerization initiator to the aqueous medium is preferable, and the polymerizable monomer (mixture) is more preferably added by dropping from the viewpoint of simplicity.

On the other hand, when the release agent is dispersed together with the monomer in the first stage polymerization, (2) a method of adding the polymerization initiator after adding the polymerizable monomer (mixture) and the release agent to the aqueous medium is preferable. To make the dispersibility of the release agent satisfactory, stirring is preferably performed by imparting mechanical energy after adding the mixture of the release agent and the first polymerizable monomer to the aqueous medium, and a disperser such as a homogenizer, a low-speed shear disperser, a high-speed shear disperser, a friction disperser, a high-pressure jet disperser, an ultrasonic disperser, a high-pressure impact disperser, or Ultimizer is preferably used. As the disperser, a commercially available product can also be used, and, for example, “CLEARMIX” (manufactured by M Technique Co., Ltd.) can be used. The first polymerizable monomer and the release agent are preferably emulsified/dispersed using a surfactant at the time of emulsion polymerization.

The surfactant is not particularly limited, and, for example, ionic surfactants shown below can each be used as a preferred surfactant. The ionic surfactants include a sulfonic acid salt, a sulfuric acid ester salt, a fatty acid salt, and the like, and examples of the sulfonic acid salt include sodium dodecylbenzene sulfonate, a sodium aryl alkyl polyether sulfonate, sodium 3,3-disulfone diphenyl urea-4,4-diazo-bis-amino-8-naphthol-6-sulfonate, o-carboxybenzene-azo-dimethylaniline, and sodium 2,2,5,5-tetramethyl-triphenylmethane-4,4-diazo-bis-β-naphthol-6 sulfonate,

Examples of the sulfuric acid ester salt include sodium dodecyl sulfate, sodium lauryl sulfate, sodium tetradecyl sulfate, sodium pentadecyl sulfate, and sodium octyl sulfate, and the fatty acid salt includes sodium oleate, sodium laurate, sodium caprate, sodium caprylate, sodium caproate, potassium stearate, calcium oleate, sodium polyoxyethylene-2-dodecyl ether sulfate, and the like.

As the surfactant, a nonionic surfactant can also be used, and specifically includes a polyethylene oxide, a polypropylene oxide, a combination of a polypropylene oxide and a polyethylene oxide, an ester of a polyethylene glycol and a higher fatty acid, an alkylphenol polyethylene oxide, an ester of a higher fatty acid and a polypropylene oxide, a sorbitan ester, and the like.

These surfactants may be used singly, or two or more thereof may be used together.

(Chain Transfer Agent)

A known chain transfer agent can also be used in order to adjust the molecular weight of the binder resin. Specifically, the chain transfer agent includes octyl mercaptan, dodecyl mercaptan, tert-dodecyl mercaptan, n-octyl-3-mercaptopropioic acid ester, terpinolene, carbon tetrabromide, oc-methylstyrene dimer, and the like.

(Polymerization Initiator)

The polymerization of the polymerizable monomer is preferably performed in the presence of a radical polymerization initiator.

The polymerization initiator which is used when the polymerizable monomer is polymerized is not particularly limited, and a known polymerization initiator can be used. When the resin fine particle is formed by an emulsion polymerization method, a water-soluble radical polymerization initiator is usable. The water-soluble radical polymerization initiator includes persulfates, such as potassium persulfate and ammonium persulfate, azobisaminodipropane acetate, azobiscyanovaleric acid and salts thereof, hydrogen peroxide, and the like. In the present embodiment, an emulsion polymerization method is suitably used, and therefore the polymerization initiator is more preferably potassium persulfate (KPS).

The amount of the polymerization initiator to be added is appropriately set in such a way as to allow the polymerization to progress, and is preferably 0.1 to 20 parts by mass based on 100 parts by mass of the polymerizable monomer at the time of the polymerization.

(Resin Fine Particle)

The volume average particle diameter of the resin fine particle obtained by the polymerization is preferably 50 to 400 nm, more preferably 60 to 200 nm.

[Aggregation and Fusion-Bonding]

In aggregation (forming aggregated particles, described above), the binder resin particle dispersion liquid containing a release agent, the crystalline polyester resin particle dispersion liquid, and the colorant dispersion liquid are put into an aqueous medium, and a resultant mixture is mixed to prepare a mixed dispersion liquid, and an aggregating agent is added into this mixed dispersion liquid to aggregate the binder resin particle containing a release agent, the crystalline polyester resin particle, and the colorant.

A base, such as a sodium hydroxide aqueous solution, is preferably added to the dispersion liquid of the resin fine particle to adjust pH to 9 to 12 in advance before adding the aggregating agent in order to impart an aggregation property.

Subsequently, the aggregating agent is added to the dispersion liquid. The addition temperature and the addition speed are not particularly limited, and the addition is preferably performed at 25 to 35° C. over 5 to 15 minutes under stirring.

The aggregating agent which is usable is not particularly limited, and the aggregating agent which is selected from metal salts is suitably used. Examples of the metal salts include: salts of a divalent metal, such as calcium, magnesium, manganese, zinc, or copper; and salts of a trivalent metal, such as iron or aluminum. Specific salts include calcium chloride, magnesium chloride, zinc chloride, copper sulfate, magnesium sulfate, manganese sulfate, and the like. The abovementioned aggregating agents may be used singly, or two or more thereof may be used in combination.

As the amount of the aggregating agent to be used, 5 to 30 parts by mass of the aggregating agent based on 100 parts by mass of the whole amount of the solids in the dispersion liquid is adequate.

When the aggregation is performed, the standing time (time until the start of heating) during which the dispersion liquid is left to stand after adding the aggregating agent is preferably shorten as much as possible. The standing time is usually set to be within 30 minutes, and is preferably within 10 minutes, more preferably 2 to 6 minutes. The temperature at which the aggregating agent is added is not particularly limited, and is preferably equal to or lower than the glass transition temperature of the binder resin.

When the aggregation is performed, heating and temperature-increasing are preferably performed. Heating is preferably performed at a heating temperature in the range of 70 to 95° C. and at a temperature increasing rate in the range of 1 to 15° C./min.

When the aggregated particles have a desired particle diameter, the aggregation of the various types of the particles in the reaction system may be stopped. The aggregation is stopped by adding an aggregation-stopping agent, such as a chelate compound which can adjust pH or an inorganic salt compound such as sodium chloride. The median diameter on a volume basis can be measured by, for example, Coulter Multisizer 3 manufactured by Coulter Beckman, Inc.

In the fusion-bonding, the aggregated particles obtained by the aggregation are fusion-bonded, and the fusion-bonding is preferably performed at a temperature equal to or higher than the glass transition temperature of the binder resin. After the temperature reaches a temperature equal to or higher than the glass transition temperature of the binder resin, fusion-bonding is continued by retaining the temperature of the dispersion liquid for a certain time. Thereby, growth of the particle (aggregation of the resin particles) and fusion-bonding of the resin particles in the aggregated particles can be allowed to progress effectively. The retention time may be performed to such an extent that the particles are fused, and the temperature may be retained for about 0.5 to 10 hours at the maximum temperature during the fusion-bonding.

The aggregation and the fusion-bonding are preferably performed until the toner matrix particle have a derided median diameter on a volume basis and a desired circularity. The growth of the toner matrix particle can be stopped by adding a sodium chloride aqueous solution or the like.

With respect to obtaining the toner matrix particle, aggregating and fusion-bonding the resin particles containing a release agent are preferably performed over a plurality of times. By performing the aggregation and the fusion-bonding over a plurality of times, the toner matrix particle having a multi-layered structure is formed, enabling dispersion of the release agent at a proper position in the toner matrix particle.

[Cooling]

In the cooling after the fusion-bonding, cooling to 0 to 45° C. is preferably performed.

A fusion-bonded particles obtained by fusion-bonding can be made into the toner matrix particle through solid-liquid separation, such as filtration, and washing and drying as necessary.

[Filtration/Washing]

In this filtration/washing, filtration processing in which the toner matrix particle is filtrated and separated by separating the toner matrix particle by solid-liquid separation using a solvent, such as water, from the cooled dispersion liquid of the toner matrix particle and washing processing in which an accretion, such as a surfactant, is removed from the filtrated-and-separated toner matrix particle (cake-like assembly) are applied. Specifically, the methods for solid-liquid separation and washing include: a centrifugal separation method; a filtration method under reduced pressure, the filtration method using an aspirator, a Nutsche, or the like; a filtration method using a filter press or the like; and the like, and these are not particularly limited. In this filtration/washing, pH adjustment, pulverization, or the like may appropriately be performed. Such operation may be performed repeatedly.

[Drying]

In this drying, thy processing is applied to the washing-processed toner matrix particle. The drying machine which is used in this drying includes an oven, a spray dryer, a vacuum freeze drying machine, a reduced-pressure drying machine, a static shelf drying machine, a moving type shelf drying machine, a fluidized bed drying machine, a rotary type drying machine, a stirring type drying machine, and the like, and these are not particularly limited. It is to be noted that the water content, which is measured by a Karl Fischer coulometric titration method, in the dry-processed particle is preferably 5% by mass or less, more preferably 2% by mass or less.

Moreover, when the dry-processed particles aggregate by weak interparticle attractive force to form an aggregate, the aggregate may be subjected to disintegration processing. As a disintegration processing apparatus herein, a mechanical disintegration apparatus, such as a jet mill, a co-mill, a Henschel mixer, a coffee mill, or a food processor, can be used.

[3] Developing Agent for Developing Electrostatic Latent Image

The toners are each constituted by the toner particle itself in the case of a one-component developing agent, and each constituted by the toner particle and a carrier particle in the case of a two-component developing agent. The content of the toner particle (toner concentration) in the two-component developing agent may be the same as that in a usual two-component developing agent, and is, for example, 4.0 to 8.0% by mass.

The carrier particle is constituted by a magnetic substance. Examples of the carrier particle include: a coating type carrier particle having a core material particle composed of the magnetic substance and a layer of a coating material that coats the surface of the core material particle; and a resin-dispersed type carrier particle containing a fine powder of the magnetic substance, the fine powder dispersed in a resin. The carrier particle is preferably the coating type carrier particle from the viewpoint of suppressing adhesion of the carrier particle to a photoreceptor.

The core material particle is constituted by a magnetic substance, for example, a substance that is strongly magnetized by a magnetic field in a direction of the magnetic field. The magnetic substance may be one or more, and examples thereof include metals, such as iron, nickel, and cobalt, which exhibit ferromagnetism, an alloy or compound containing any one of these metals, and an alloy which exhibits ferromagnetism by applying heat processing thereon.

Examples of the metals which exhibit ferromagnetism or the compound containing any one of the metals include iron, ferrite represented by the following formula (a), and magnetite represented by the following formula (b). M in formula (a) and formula (b) represents one or more monovalent or divalent metals selected from the group consisting of Mn, Fe, Ni, Co, Cu, Mg, Zn, Cd, and Li.

MO.Fe₂O₃ Formula (a):

Formula Formula (b):

Moreover, examples of the alloy or metal oxide which exhibits ferromagnetism by applying heat processing thereon include: Hensler alloys, such as manganese-copper-aluminum and manganese-copper-tin; and chromium dioxide.

The core material particle is preferably the ferrite. This is because the specific gravity of the coating type carrier particle is smaller than the specific gravity of the metals that constitute the core material particle and therefore the impact of stirring in a developing apparatus can be made smaller.

The coating material may be one or more. As the coating material, a known resin which is utilized for coating a core material particle of a carrier particle can be used. The coating material is preferably a resin having a cycloalkyl group from the viewpoint of reducing the water adsorptivity of the carrier particle and the viewpoint of enhancing the adhes iveness of the coating layer to the core material particle. Examples of the cycloalkyl group include a cyclohexyl group, a cyclopentyl group, a cyclopropyl group, a cyclobutyl group, a cycloheptyl group, a cyclooctyl group, a cyclononyl group, and a cyclodecyl group. Among others, a cyclohexyl group or a cyclopentyl group is preferable, and from the viewpoint of the adhesiveness between the coating layer and a ferrite particle, the cycloalkyl group is more preferably a cyclohexyl group.

The weight average molecular weight of the resin having a cycloalkyl group is, for example, 10000 to 800000, more preferably 100000 to 750000. The content of the cycloalkyl group in the resin is, for example, 10 to 90% by mass. The content of the cycloalkyl group in the resin can be determined by utilizing a known instrumental analysis method, such as, for example, P-GC/MS or ¹H-NMR.

The two-component developing agent can be produced by mixing the toner particle and the carrier particle each in an appropriate amount. Examples of a mixing apparatus which is used for the mixing include a Nauta mixer, and W cone type and V type mixing machines.

Moreover, the size and shape of the carrier particle can also appropriately be determined in a range where the effects of the present embodiment are obtained. For example, the volume average particle diameter of the carrier particle is preferably in the range of 15 to 100 μm, more preferably in the range of 20 to 60 μm. The volume average particle diameter of the carrier particle can be measured by a wet process using, for example, a laser diffraction type particle size distribution analyzer “HELOS KA” (manufactured by Sympatec GmbH). Moreover, the volume average particle diameter of the carrier particle can be adjusted by, for example, a method of controlling the particle diameter of the core material particle by the condition of producing the core material particle; classification of the carrier particle; and mixing of products obtained by classifying the carrier particle.

[4] Electrophotographic Image Forming Method and Apparatus

The electrophotographic image forming method of the present invention is an electrophotographic image forming method using at least a yellow toner, a magenta toner, and a cyan toner, wherein the electrostatic latent image developing toner set of the present invention is used.

Moreover, the electrophotographic image forming method of the present invention is an image forming method including at least: latent image formation; development; intermediate transfer; transferring; fixing; and cleaning, that is, the electrophotographic image forming method of the present invention includes the following steps.

1) Charging a surface of an electrostatic charge image carrier,

2) Forming an electrostatic latent image on the electrostatic charge image carrier by exposing the surface of the electrostatic charge image carrier,

3) Performing development by visualizing the electrostatic latent image by a developing agent containing an electrostatic latent image developing toner, thereby forming a toner image,

4) Performing intermediate transfer by transferring the toner image on an intermediate transfer body; and transferring the toner image on an image forming support,

5) Fixing the toner image formed on the image forming support, and

6) Cleaning by removing a residual electrostatic latent image developing toner using a cleaning blade.

The electrostatic charge image carrier (electrophotographic photoreceptor, or also simply referred to as photoreceptor) can be used in known, various image forming methods in electrophotographic systems. For example, the electrostatic charge image carrier can be used in a monochromatic image forming method or a full color image forming method. Any of the image forming methods, such as an image forming method in a four-cycle system configured by four types of color developing apparatuses relating to yellow, magenta, cyan, and black, respectively, and one photoreceptor, and an image forming method in a tandem system including an image forming unit having a color developing apparatus and a photoreceptor each relating to an individual color and each installed for every color, can be used among the full color image forming methods.

As the electrophotographic image forming method of the present invention, specifically, charging is performed using the photoreceptor on the photoreceptor with a charging apparatus (charging), and an electrostatic latent image formed by exposure of an image (exposure) is visualized by performing development using a developing apparatus (development), thereby obtaining a toner image. This toner image is transferred onto a transfer medium, such as a copy sheet or a transfer belt (transfer), and the next cycle of image formation is then performed after removing electricity. The toner image transferred onto the transfer medium, such as a transfer belt, is transferred onto a copy sheet, and by fixing the toner image transferred onto the copy sheet by fixation processing of a contact heating type or the like (fixing), an visible image is obtained. A toner which is left on the photoreceptor after the transfer (toner left after transfer) is removed by a cleaning blade (rubber blade) or the like (cleaning). This cleaning may be performed before or after removing electricity, and in the case of removing electricity by light irradiation, removing electricity is preferably performed after the cleaning because the toner left on the photoreceptor does not inhibit absorption of light for removing electricity and therefore removing electricity can effectively be performed.

It is to be noted that when the photoreceptor has a curable type surface layer, there is an advantage, such as that the durability of the photoreceptor is improved, but on the other hand, the surface layer of the photoreceptor is hard to scrape and therefore an image failure occurs in some cases when a developing agent which is liable to cause filming or the like on the surface of the photoreceptor is used. The use of the electrostatic latent image developing toner set of the present invention enables suppressing the occurrence of filming or the like of the photoreceptor, and also enables reducing the frequency of exchanging photoreceptor units due to filming, wear of a blade, or the like, thereby enabling maximization of advantages of using the photoreceptor having a curable type surface layer.

The curable type surface layer is formed on the outer circumferential surface of the photoreceptor, and is preferably obtained by irradiating a coating film of a coating liquid for forming a surface layer, the coating liquid containing: a fine particle of a metal oxide, such as antimony-doped tin oxide, titanium oxide, zinc oxide, nickel, copper, silver, or germanium; and an active energy ray-curable composition containing a (meth)acrylate monomer and a multifunctional (meth)acrylate monomer other than the (meth)acrylate monomer, with an active energy ray, thereby curing the coating film.

The fine particle of a metal oxide is preferably composed of a surface-processed fine particle of a metal oxide.

[Electrophotographic Image Forming Apparatus]

Next, a specific electrophotographic image forming method will be described with an electrophotographic image forming apparatus.

The electrophotographic image forming apparatus includes: a charger that uses the photoreceptor to perform charging on the photoreceptor with a charging apparatus; an exposer that forms an electrostatic latent image formed by exposing an image; a developer that performs development using a developing apparatus to perform visualization, thereby obtaining a toner image; a transferer that transfers this toner image onto a transfer medium, such as a sheet or a transfer belt; and an electricity remover. A visible image is obtained from the toner image directly transferred onto the copy sheet and the toner image transferred onto the sheet through the transfer medium, such as a transfer belt, by a fixer that performs fixation on the copy sheet by fixation processing of a contact heating type or the like. The toner left on the photoreceptor after the transfer (toner left after transfer) is removed by a cleaner, such as a cleaning blade.

≤Recording Medium>

A recording medium (also referred to as recording material, recording paper, or recording sheet or the like) which is used in the electrophotographic image forming method of the present invention may be a generally used recording medium, and is not particularly limited as long as it retains a toner image formed by a known image forming method with, for example, an image forming apparatus. Examples of the recording medium which is used as a usable image support include: plain paper from thin paper to thick paper; wood-free paper; art paper or a coated printing sheet, such as coated paper; commercially available Japanese paper and postcard sheets; a plastic film for OHP; cloth; and various resin materials which are used for so-called soft packaging, or resin films and labels obtained by forming such various resin materials into films.

<Image Forming Apparatus>

The electrophotographic image forming method of the present invention can be performed by using a conventionally known image forming apparatus of an electrophotographic system.

The image forming apparatus includes: a photoreceptor; an electrostatic latent image former that forms an electrostatic latent image on the photoreceptor; a toner image former that develops the electrostatic latent image with a toner, thereby forming a toner image; a transferer that transfers the formed toner image onto a sheet; a fixer that fixes the transferred toner image on the sheet; and the like.

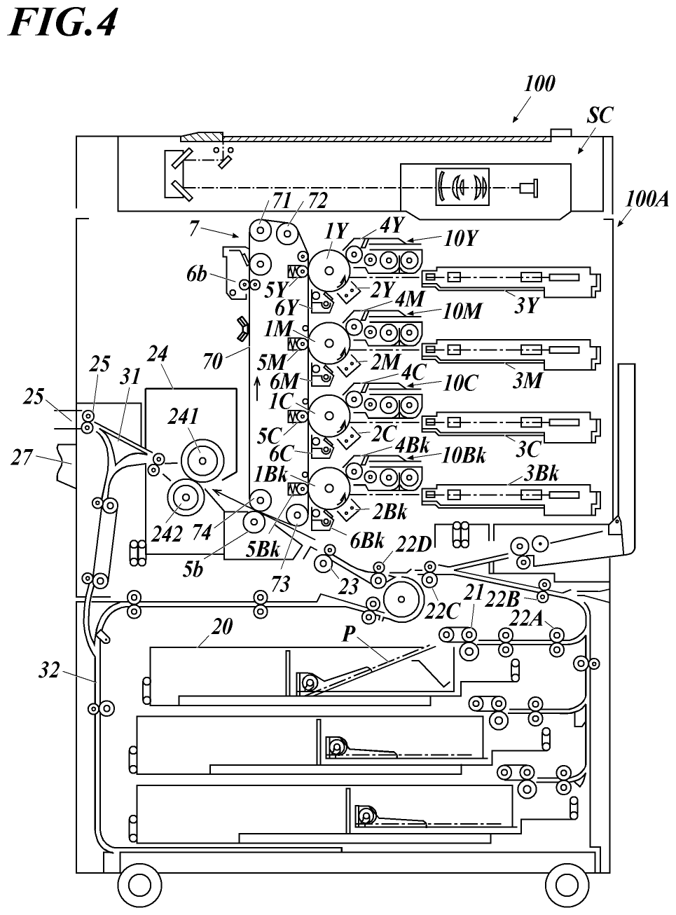

FIG. 4 is an outline configuration diagram showing one example of the configuration of the image forming apparatus which is used in the image forming method of the present invention.

An image forming apparatus 100 shown in FIG. 4 includes an image forming apparatus main body 100A provided with: image forming units 10Y, 10M, 10C, 10Bk that form yellow, magenta, cyan, or black toner image, respectively; an intermediate transfer unit 7 that transfers toner images of the colors, the toner images formed in these image forming units 10Y, 10M, 10C, 10Bk onto a sheet P; and a fixer 24 that fixes the toner images to the sheet P. Moreover, a manuscript image reading apparatus SC that optically scans a manuscript to read image information as digital data (manuscript image data) is disposed at an upper part of the image forming apparatus main body 100A.

The image forming units 10M, 10C, 10Bk basically have the same configuration as the image forming unit 10Y because the image forming units form toner images with a magenta toner, a cyan toner, and a black toner, respectively, in place of a yellow toner. Accordingly, description will hereinafter be made taking the image forming unit 10Y as an example, and description on the image forming units 10M, 10C, 10Bk is omitted. The image forming unit 10Y includes: a charger 2Y that gives uniform electric potential on a surface of a drum-like photoreceptor 1Y; an exposer 3Y that performs exposure on the uniformly charged photoreceptor 1Y based on an image data signal (yellow) for exposure, thereby forming an electrostatic latent image corresponding to a yellow image; a developer 4Y that conveys a toner on the photoreceptor 1Y to visualize the electrostatic latent image; and a cleaner 6Y that collects a residual toner left on the photoreceptor 1Y after a primary transfer, each disposed around the drum-like photoreceptor 1Y which is an image forming body, and forms a yellow (Y) toner image on the photoreceptor 1Y. It is to be noted that a toner having, for example, a content of an external additive adjusted in such a way that the resistance value at 70° C. on the image surface of an image to be formed, as measured by a temperature changing method, is 5×10¹³ Ω or less is loaded in the developer 4Y.

As the charger 2Y, a corona discharge type charging device is used.

The exposer 3Y includes: a light irradiation apparatus using light emitting diodes as exposure light sources, the light irradiation apparatus configured by LED in which, for example, light emitting elements each composed of a light emitting diode are disposed in the form of an array in the axial direction of the photoreceptor 1Y, and imaging elements; a laser irradiation apparatus using semiconductor laser as an exposure light source, the laser irradiation apparatus having a laser optical system; or the like. In the image forming apparatus 100 shown in FIG. 4, a laser irradiation apparatus is provided.

The exposer 3Y desirably includes an apparatus using semiconductor laser or light emitting diode with an oscillation wavelength of 350 to 800 nm as an exposure light source. When digital exposure is performed on the photoreceptor 1Y using such an exposure light source in such a way as to stop an exposure dot diameter in the main scanning direction of writing into 10 to 100 μm, an electrophotographic image with high resolution, as high as 600 dpi to 2400 dpi or higher can thereby be obtained.

An exposure method in the exposer 3Y may be a scanning optical system using semiconductor laser, or a solid type with LED.

The intermediate transfer unit 7 is stretched by a plurality of supporting rollers 71 to 74 and includes: an endless belt-like intermediate transfer body 70 supported in such a way as to be movable in a circulative manner; primary transfer rollers 5Y, 5M, 5C, 5Bk that transfer the toner images formed with the image forming unit 10Y, 10M, 10C, 10Bk, respectively, onto the intermediate transfer body 70; a secondary transfer roller 5b that transfers the toner images on to the sheet P, the toner images transferred onto the intermediate transfer body 70 by the primary transfer rollers 5Y, 5M, 5C, 5Bk; and a cleaner 6b that collects residual toners left on the intermediate transfer body 70.

The primary transfer roller 5Bk in the intermediate transfer unit 7 is allowed to abut on a photoreceptor 1Bk at all times during image formation processing, and the other primary transfer rollers 5Y, 5M, 5C are allowed to abut on the corresponding photoreceptors 1Y, 1M, 1C, respectively, only when a color image is formed.

Moreover, the secondary transfer roller 5b is allowed to abut on the intermediate transfer body 70 only when the sheet P passes through the secondary transfer roller 5b and the secondary transfer is performed.

The fixer 24 is configured in such a way as to be provided with, for example,: a heating roller 241 provided with a heating source inside; and a pressure roller 242 installed in a state of being brought into pressure contact with this heating roller 241 in such a way that a fixing nipper is formed.

In the image forming apparatus 100 as described above, the surfaces of the photoreceptors 1Y, 1M, 1C, 1Bk are charged with chargers 2Y, 2M, 2C, 2Bk. Subsequently, the exposers 3Y, 3M, 3C, 3Bk are operated according to image data signals for exposure of the colors, respectively, the image data signals obtained in such a way that various types of image processing and the like are applied to the manuscript image data obtained with the manuscript image reading apparatus SC. Specifically, laser light modulated according to the image data signals for exposure is output from an exposure light source, and the photoreceptors 1Y, 1M, 1C, 1Bk are exposed by scanning with this laser light. Thereby, electrostatic latent images corresponding to the colors of yellow, magenta, cyan, and black, respectively, the latent images corresponding to the manuscript read by the manuscript image reading apparatus SC, are formed on the photoreceptors 1Y, 1M, 1C, 1Bk, respectively.

Subsequently, the electrostatic latent images formed on the photoreceptors 1Y, 1M, 1C, 1Bk are developed by the toners of the colors, respectively, with the developers 4Y, 4M, 4C, 4Bk, and respective toner images of the colors are thereby formed. Subsequently, the respective toner images of the colors are transferred successively by the primary transfer rollers 5Y, 5M, 5C, 5Bk onto the intermediate transfer body 70 to be superimposed and synthesized, and thus a color toner image is formed.

Further, the sheet P stored in a paper feed cassette 20 is fed by a paper feeder 21 in synchronization with the formation of the color toner image, and is conveyed to the secondary transfer roller 5b through a plurality of intermediate rollers 22A, 22B, 22C, 22D and a resist roller 23. Thus, the color toner image transferred onto the intermediate transfer body 70 by the secondary transfer roller 5b is transferred onto the sheet P in a lump.

The color toner image transferred onto the sheet P is fixed when subjected to heating and pressurization with the fixer 24, and thus a visible image (toner layer) is formed. Thereafter, the sheet P having the visible image formed thereon is discharged outside the machine from an outlet 26 by a paper discharging roller 25 to be placed on a paper discharging tray 27.

The photoreceptors 1Y, 1M, 1C, 1Bk after transferring the respective toner images of the colors onto the intermediate transfer body 70 are provided for forming respective next toner images of the colors after the toners left on the photoreceptors 1Y, 1M, 1C, 1Bk are removed by the cleaners 6Y, 6M, 6C, 6Bk, respectively.

On the other hand, the intermediate transfer body 70 after transferring the color toner image onto the sheet P by the secondary transfer roller 5b and curvedly separating the sheet P is provided for the intermediate transfer of the next toner images after the toners left on the intermediate transfer body 70 are removed by the cleaner 6b.

When the electrostatic latent image developing tone set of the present invention is used as the toners which are used in the image forming apparatus as described above, high transfer efficiency/ high image quality and cleaning performance can thereby be improved while the low-temperature fixability is realized.

The embodiments of the present invention have been described above, but the present invention is not limited to the embodiments, and various modifications can be added to the embodiments.

Hereinafter, the present invention will specifically be described giving Examples, but the present invention is not limited to these Examples. It is to be noted that “part(s)” or “%” used in Examples represents “parts by mass” or “% by mass” unless otherwise noted.

«Production of Toners»

[Preparation of Amorphous Resin Fine Particle Dispersion Liquid (Amorphous Dispersion Liquid) 1]

(1) First Stage Polymerization

In a 5 L reaction container having a stirring apparatus, a temperature sensor, a cooling tube, and a nitrogen introducing apparatus attached thereto, 8 parts by mass of sodium dodecyl sulfate and 3000 parts by mass of ion-exchanged water were placed, and the internal temperature of the reaction container was increased to 80° C. under stirring at a stirring speed of 230 rpm in a nitrogen gas stream. After the temperature was increased, an aqueous solution obtained by dissolving 10 parts by mass of potassium persulfate in 200 parts by mass of ion-exchanged water was added to a resultant mixed liquid, and the temperature of a resultant mixed liquid was increased to 80° C. again. After monomer mixed liquid 1 consisting of the following composition was dropped into the mixed liquid over 1 hour, the mixed liquid was heated and stirred at 80° C. for 2 hours to perform polymerization, thereby preparing dispersion liquid al of a resin fine particle.

(Monomer Mixed Liquid 1)

| | | |
|---|---|---|
| Styrene | 480 | parts by mass |
| n-Butyl acrylate | 250 | parts by mass |
| Methacrylic acid | 68 | parts by mass |

(2) Second Stage Polymerization

In a 5 L reaction container having a stirring apparatus, a temperature sensor, a cooling tube, and a nitrogen introducing apparatus attached thereto, a solution obtained by dissolving 7 parts by mass of sodium polyoxyethylene (2) dodecyl ether sulfate in 3000 parts by mass of ion-exchanged water was placed, and after the solution was heated to 80° C., 80 parts by mass of dispersion liquid al of a resin fine particle (in terms of solids) and monomer mixed liquid 2 consisting of the following composition, the monomer mixed liquid obtained by dissolving monomers and a release agent at 90° C., were added to the solution, and a resultant mixture was mixed and dispersed for 1 hour with a mechanical disperser “CLEARMIX” (manufactured by M Technique Co., Ltd., “CLEARMIX” is a registered trade mark of the company) having a circulation path to prepare a dispersion liquid containing an emulsified particle (oil droplet). Hydrocarbon wax 1 described below is a release agent and has a melting point of 82° C.

(Monomer Mixed Liquid 2)

| | | |
|---|---|---|
| Styrene | 285 | parts by mass |
| 2-Ethylhexyl acrylate | 95 | parts by mass |
| Methacrylic acid | 20 | parts by mass |
| n-Octyl-3-mercaptopropionate | 8 | parts by mass |
| Hydrocarbon wax 1 (C 80 (manufactured by | 190 | parts by mass |
| Sasol Limited)) | | |

Subsequently, an initiator solution obtained by dissolving 6 parts by mass of potassium persulfate in 200 parts by mass of ion-exchanged water was added to the dispersion liquid, and polymerization was performed by heating and stirring a resultant dispersion liquid at 84° C. over 1 hour to prepare dispersion liquid a2 of a resin fine particle.

(3) Third Stage Polymerization

Further, after 400 parts by mass of ion-exchanged water was added to dispersion liquid a2 of a resin fine particle, and a resultant mixture was mixed sufficiently, a solution obtained by dissolving 11 parts by mass of potassium persulfate in 400 parts by mass of ion-exchanged water was added to a resultant dispersion liquid, and monomer mixed liquid 3 consisting of the following composition was dropped thereinto under a temperature condition of 82° C. over 1 hour. After the dropping was completed, polymerization was performed by heating and stirring the dispersion liquid over 2 hours, and cooling was then performed to 28° C. to prepare amorphous resin fine particle dispersion liquid (hereinafter, also referred to as “amorphous dispersion liquid”) 1 containing a vinyl resin (styrene/acrylic resin).

(Monomer Mixed Liquid 3)

| | | |
|---|---|---|
| Styrene | 307 | parts by mass |
| n-Butyl acrylate | 147 | parts by mass |
| Methacrylic acid | 52 | parts by mass |
| n-Octyl-3-mercaptopropionate | 8 | parts by mass |

The physical properties of resultant amorphous dispersion liquid 1 were measured to find that the amorphous resin fine particle had a median diameter (d50) of 220 nm on a volume basis, a glass transition temperature (Tg) of 46° C., and a weight average molecular weight (Mw) of 32000.

[Preparation of Amorphous Resin Fine Particle Dispersion Liquids 2 to 7]

Amorphous resin fine particle dispersion liquids (amorphous dispersion liquids) 2 to 7 were each obtained in the same manner as in the preparation of amorphous dispersion liquid 1, except that hydrocarbon wax 1 in the second stage polymerization was changed to a release agent shown in Table 1.

TABLE 1
Table I

| | Wax | | | | | |
|---|---|---|---|---|---|---|
| Amorphous resin fine particle | | | Ratio | | | Ratio |
| dispersion liquid No. | Wax type | | (% by mass) | Type | | (% by mass) |
| Amorphous resin fine particle | Hydrocarbon 1 | Fischer-Tropsch (melting | 100 | — | — | — |
| dispersion liquid 1 | | point 82° C.) | | | | |
| Amorphous resin fine particle | Hydrocarbon 2 | Microcrystalline (melting | 100 | — | — | — |
| dispersion liquid 2 | | point 86° C.) | | | | |
| Amorphous resin fine particle | Hydrocarbon 3 | Fischer-Tropsch (melting | 100 | — | — | — |
| dispersion liquid 3 | | point 86° C.) | | | | |
| Amorphous resin fine particle | Ester 1 | Monoester (melting | 100 | — | — | — |
| dispersion liquid 4 | | point 88° C.) | | | | |
| Amorphous resin fine particle | Ester 2 | Monoester (melting | 100 | — | — | — |
| dispersion liquid 5 | | point 78° C.) | | | | |
| Amorphous resin fine particle | Hydrocarbon 2 | Microcrystalline (melting | 5 | Ester 3 | Monoester (melting | 95 |
| dispersion liquid 6 | | point 86° C.) | | | point 72° C.) | |
| Amorphous resin fine particle | Hydrocarbon 4 | Paraffin (melting | 100 | — | — | — |
| dispersion liquid 7 | | point 94° C.) | | | | |

[Synthesis of Crystalline Polyester Resin 1]

In a reaction container provided with a stirrer, a thermometer, a cooling tube, and a nitrogen gas introducing tube, 281 parts by mass of sebacic acid and 283 parts by mass of 1,10-decanediol were placed. After the inside of the reaction container was replaced with a dried nitrogen gas, 0.1 parts by mass of Ti(OBu)₄ was added thereto, and reaction was performed by stirring a resultant mixed liquid in a nitrogen gas stream at about 180° C. for 8 hours. Further, 0.2 parts by mass of Ti(OBu)₄ was added to the mixed liquid, and reaction was performed by raising the temperature of the mixed liquid to about 220° C. and stirring the mixed liquid for 6 hours. Thereafter, the pressure in the reaction container was reduced to 1333.2 Pa, and reaction was performed under reduced pressure to obtain crystalline polyester resin 1. Crystalline polyester resin 1 had a number average molecular weight (Mn) of 5500, a weight average molecular weight (Mw) of 18000, and a melting point (Tm) of 70° C.

[Preparation of Crystalline Resin Fine Particle Dispersion Liquid (Crystalline Dispersion Liquid) 1]

Crystalline polyester resin 1 in an amount of 30 parts by mass was transported in a molten state to an emulsifying disperser “Cavitron CD1010 (manufactured by Euro Tec, Ltd.) at a transportation speed of 100 parts by mass per minute. Simultaneously, dilute ammonia water having a concentration of 0.37% by mass was transported to the emulsifying disperser at a transportation speed of 0.1 liters per minute while being heated at 100° C. with a heat exchanger. The dilute ammonia water was prepared by diluting 70 parts by mass of reagent ammonia water with ion-exchanged water in an aqueous solvent tank. Subsequently, crystalline resin fine particle dispersion liquid (crystalline dispersion liquid) 1 of crystalline polyester resin 1, the crystalline resin fine particle dispersion liquid having a solid content of 30 parts by mass, was prepared by operating the emulsifying disperser under a condition that the rotational speed of a rotor was 60 Hz and the pressure was 5 kg/cm² (490 kPa). The particle of crystalline polyester resin 1 contained in crystalline dispersion liquid 1 had a median diameter (d50) of 200 nm on a volume basis.

[Preparation of Colorant Dispersion Liquid C1]

Sodium dodecyl sulfate in an amount of 90 parts by mass was stirred and dissolved in 1600 parts by mass of ion-exchanged water, and 420 parts by mass of C.I. Pigment Blue 18:3 was gradually added to this solution under stirring.

Subsequently, a resultant dispersion liquid was subjected to dispersion processing using a stirring apparatus “CLEARMIX” (manufactured by M Technique Co., Ltd.) and colorant fine particle dispersion liquid (colorant dispersion liquid) C1 containing a colorant fine particle dispersed therein was thereby prepared. The median diameter d50 on a volume basis in colorant dispersion liquid C1, as measured using a Microtrack particle size distribution analyzer “UPA-150” (manufactured by NIKKISO CO., LTD.), was 150 nm.

[Preparation of Colorant Dispersion Liquid Y1]

Sodium dodecyl sulfate in an amount of 90 parts by mass was stirred and dissolved in 1600 parts by mass of ion-exchanged water, and 420 parts by mass of C.I. Pigment Yellow 74 was gradually added to this solution under stirring.

Subsequently, a resultant dispersion liquid was subjected to dispersion processing using a stirring apparatus “CLEARMIX” (manufactured by M Technique Co., Ltd.) and colorant fine particle dispersion liquid (colorant dispersion liquid) Y1 containing a colorant fine particle dispersed therein was thereby prepared. The median diameter d50 on a volume basis in colorant dispersion liquid Y1, as measured using a Microtrack particle size distribution analyzer “UPA-150” (manufactured by NIKKISO CO., LTD.), was 150 nm.

[Preparation of Colorant Dispersion Liquid M1]

Sodium dodecyl sulfate in an amount of 90 parts by mass was stirred and dissolved in 1600 parts by mass of ion-exchanged water, and C.I. Pigment Red 122, 269, and 48:3 each in an amount of 140 parts by mass were gradually added to this solution under stirring.

Subsequently, a resultant dispersion liquid was subjected to dispersion processing using a stirring apparatus “CLEARMIX” (manufactured by M Technique Co., Ltd.) and colorant fine particle dispersion liquid (colorant dispersion liquid) M1 containing a colorant fine particle dispersed therein was thereby prepared. The median diameter d50 on a volume basis in colorant dispersion liquid M1, as measured using a Microtrack particle size distribution analyzer “UPA-150” (manufactured by NIKKISO CO., LTD.), was 200 nm.

[Preparation of Colorant Dispersion Liquid B1]

Sodium dodecyl sulfate in an amount of 90 parts by mass was stirred and dissolved in 1600 parts by mass of ion-exchanged water, and 420 parts by mass of carbon black was gradually added to this solution under stirring.

Subsequently, a resultant dispersion liquid was subjected to dispersion processing using a stirring apparatus “CLEARMIX” (manufactured by M Technique Co., Ltd.) and colorant fine particle dispersion liquid (colorant dispersion liquid) B1 containing a colorant fine particle dispersed therein was thereby prepared. The median diameter d50 on a volume basis in colorant dispersion liquid B 1, as measured using a Microtrack particle size distribution analyzer “UPA-150” (manufactured by NIKKISO CO., LTD.), was 150 nm.

[Synthesis of Amorphous Resin 1 for Shell]

Monomer mixed liquid 6 consisting of the following composition containing an amphoteric compound (acrylic acid) was placed in a dropping funnel. It is to be noted that di-t-butyl peroxide is a polymerization initiator.

(Monomer Mixed Liquid 6)

| | |
|---|---|
| Styrene | 80 parts by mass |
| n-Butyl acrylate | 20 parts by mass |
| Acrylic acid | 10 parts by mass |
| Di-t-butyl peroxide | 16 parts by mass |

Moreover, a raw material monomer for a polycondensed segment (amorphous polyester segment), the raw material monomer described below, was placed in a four-neck flask provided with a nitrogen introducing tube, a dehydration tube, a stirrer, and a thermocouple, and was dissolved by heating the raw material monomer to 170° C.

| | | |
|---|---|---|
| Bisphenol A adduct with 2 mol of propylene | 285.7 | parts by mass |
| oxide | | |
| Terephthalic acid | 66.9 | parts by mass |
| Fumaric acid | 47.4 | parts by mass |

Subsequently, after monomer mixed liquid 6 was dropped into a resultant solution over 90 minutes under stirring, and aging was performed for 60 minutes, unreacted monomers in the components of monomer mixed liquid 6 were removed from the inside of the four-neck flask under reduced pressure (8 kPa).

Thereafter, 0.4 parts by mass of Ti(OBu)₄ as an esterification catalyst was put into the four-neck flask, the temperature of the mixed liquid in the four-neck flask was increased to 235° C. to perform reaction under normal pressure (101.3 kPa) for 5 hours, and the reaction was further performed under a reduced pressure (8 kPa) under a condition of 1 hour to obtain amorphous resin sl for a shell.

[Preparation of Resin Fine Particle Dispersion Liquid 1 for Shell (Dispersion Liquid for Shell)]

Amorphous resin sl for a shell in an amount of 100 parts by mass was dissolved in 400 parts by mass of ethyl acetate (manufactured by KANTO CHEMICAL CO., INC.), and a resultant solution was mixed with 638 parts by mass of a sodium lauryl sulfate solution having a concentration of 0.26% by mass, the sodium lauryl sulfate solution prepared in advance.

A resultant mixed liquid was dispersed under stirring by an ultrasonic wave for 30 minutes with an ultrasonic homogenizer “US-150T” (manufactured by NISSEI Corporation) under a condition that V-LEVEL was 300 μA.

Thereafter, the mixed liquid in a state of being warmed to 40° C. was stirred using a diaphragm vacuum pump “V-700” (manufactured by BUCHI Labortechnik AG) under reduced pressure for 3 hours to remove ethyl acetate completely. In this way, amorphous resin fine particle dispersion liquid 1 for a shell (dispersion liquid for a shell) having a solid content of 13.5% by mass was prepared. The median diameter (d50) of the resin particle for a shell on a volume basis in dispersion liquid 1 for a shell was 160 nm.

[Production of Color Toner C1]

After 288 parts by mass of amorphous dispersion liquid 1 (in terms of solids) and 2000 parts by mass of ion-exchanged water were put into a reaction container having a stirring apparatus, a temperature sensor, and a cooling tube attached thereto, 5 mol/liter of sodium hydroxide aqueous solution was further added to adjust pH of the dispersion liquid in the reaction container to 10 (measurement temperature 25° C.).

Colorant dispersion liquid C1 in an amount of 30 parts by mass (in terms of solids) was put into the dispersion liquid. Subsequently, an aqueous solution obtained by dissolving 30 parts by mass of magnesium chloride as an aggregating agent in 60 parts by mass of ion-exchanged water was added to the dispersion liquid under stirring at 30° C. over 10 minutes. The temperature of a resultant mixed liquid was increased to 80° C., and 40 parts by mass of crystalline dispersion liquid 1 (in terms of solids) was added to the mixed liquid over 10 minutes to allow aggregation to progress.

The particle diameter of a particle produced by association in the mixed liquid was measured with “Coulter Multisizer 3” (manufactured by Beckman Coulter, Inc.), and at a point in time when the median diameter d50 of the particle on a volume basis reached 6.0 μm, 37 parts by mass of dispersion liquid 1 for a shell (in terms of solids) was put into the mixed liquid over 30 minutes. At a point in time when the supernatant of a resultant reaction liquid became transparent, an aqueous solution obtained by dissolving 190 parts by mass of sodium chloride in 760 parts by mass of ion-exchanged water was added to the reaction liquid to stop the particle growth.

Further, fusion-bonding of particles was allowed to progress by heating the reaction liquid to 80° C. and stirring the reaction liquid, a particle in the reaction liquid was measured using a measurement apparatus “FPIA-2100” (manufactured by Sysmex Corporation) (the number of particles detected in HPF was 4000 particles), and at a point in time when the average circularity of the particle reached 0.945, the reaction liquid was cooled to 30° C. at a cooling rate of 2.5° C./min.

Subsequently, the particle was separated from the cooled reaction liquid to perform dehydration, and a resultant cake was washed by repeating re-dispersion into ion-exchanged water and solid-liquid separation 3 times and was then dried at 40° C. for 24 hours to obtain color toner matrix particle C1.

To 100 parts by mass of color toner matrix particle C1, 0.6 parts by mass of hydrophobic silica (number average primary particle diameter=12 nm, degree of hydrophobization=68) and 1.0 part by mass of hydrophobic titanium oxide (number average primary particle diameter=20 nm, degree of hydrophobization=63) were added, and after these were mixed with “Henschel Mixer” (manufactured by NIPPON COKE & ENGINEERING COMPANY, LIMITED) at a circumferential speed of rotary blades of 35 mm/sec at 32° C. for 20 minutes, coarse particles were removed using a sieve having an aperture of 45 μm. By performing such external additive processing, color toner C1, which is an aggregate of electrostatic latent image developing color toner matrix particles C1, was produced.

[Production of Toners]

Toners were produced in the same manner as in the production of color toner C1, except that amorphous dispersion liquid 1 was changed to amorphous dispersion liquids shown in Tables described below and that colorant dispersion liquid C1 was changed to colorant dispersion liquids shown in Tables described below.

TABLE 2
Table II

| | | Colorant | |
|---|---|---|---|
| Toner | Amorphous resin fine particle | dispersion | Colorant in |
| No. | dispersion liquid No. | liquid | terms of solids |
| Y1 | Amorphous resin fine particle | Colorant | 30 |
| | dispersion liquid 1 | dispersion | |
| Y2 | Amorphous resin fine particle | liquid Y1 | 30 |
| | dispersion liquid 2 | | |
| Y3 | Amorphous resin fine particle | | 30 |
| | dispersion liquid 3 | | |
| Y4 | Amorphous resin fine particle | | 30 |
| | dispersion liquid 4 | | |
| Y5 | Amorphous resin fine particle | | 30 |
| | dispersion liquid 5 | | |
| Y6 | Amorphous resin fine particle | | 30 |
| | dispersion liquid 6 | | |
| Y7 | Amorphous resin fine particle | | 30 |
| | dispersion liquid 7 | | |

TABLE 3
Table III

| | | Colorant | |
|---|---|---|---|
| Toner | Amorphous resin fine particle | dispersion | Colorant in |
| No. | dispersion liquid No. | liquid | terms of solids |
| C1 | Amorphous resin fine particle | Colorant | 30 |
| | dispersion liquid 1 | dispersion | |
| C2 | Amorphous resin fine particle | liquid C1 | 30 |
| | dispersion liquid 2 | | |
| C3 | Amorphous resin fine particle | | 30 |
| | dispersion liquid 3 | | |
| C4 | Amorphous resin fine particle | | 30 |
| | dispersion liquid 4 | | |
| C5 | Amorphous resin fine particle | | 30 |
| | dispersion liquid 5 | | |
| C6 | Amorphous resin fine particle | | 30 |
| | dispersion liquid 6 | | |
| C7 | Amorphous resin fine particle | | 20 |
| | dispersion liquid 2 | | |
| C8 | Amorphous resin fine particle | | 30 |
| | dispersion liquid 7 | | |

TABLE 4
Table IV

| | | Colorant | |
|---|---|---|---|
| Toner | Amorphous resin fine particle | dispersion | Colorant in |
| No. | dispersion liquid No. | liquid | terms of solids |
| M1 | Amorphous resin fine particle | Colorant | 30 |
| | dispersion liquid 1 | dispersion | |
| M2 | Amorphous resin fine particle | liquid M1 | 30 |
| | dispersion liquid 2 | | |
| M3 | Amorphous resin fine particle | | 30 |
| | dispersion liquid 3 | | |
| M4 | Amorphous resin fine particle | | 30 |
| | dispersion liquid 4 | | |
| M5 | Amorphous resin fine particle | | 30 |
| | dispersion liquid 5 | | |
| M6 | Amorphous resin fine particle | | 30 |
| | dispersion liquid 6 | | |
| M7 | Amorphous resin fine particle | | 20 |
| | dispersion liquid 2 | | |
| M8 | Amorphous resin fine particle | | 30 |
| | dispersion liquid 7 | | |

TABLE 5
Table V

| | | Colorant | |
|---|---|---|---|
| Toner | Amorphous resin fine particle | dispersion | Colorant in |
| No. | dispersion liquid No. | liquid | terms of solids |
| Bk1 | Amorphous resin fine particle | Colorant | 30 |
| | dispersion liquid 1 | dispersion | |
| Bk2 | Amorphous resin fine particle | liquid B1 | 30 |
| | dispersion liquid 2 | | |
| Bk3 | Amorphous resin fine particle | | 30 |
| | dispersion liquid 3 | | |
| Bk4 | Amorphous resin fine particle | | 30 |
| | dispersion liquid 4 | | |
| Bk5 | Amorphous resin fine particle | | 30 |
| | dispersion liquid 5 | | |
| Bk6 | Amorphous resin fine particle | | 30 |
| | dispersion liquid 6 | | |
| Bk7 | Amorphous resin fine particle | | 30 |
| | dispersion liquid 7 | | |

Thereafter, each toner and a ferrite carrier covering an acrylic resin, the ferrite carrier having a volume average particle diameter of 32 μm, were added and mixed in such a way that the toner particle concentration was 6% by mass. In this way, developing agents, which are two-component developing agents, each containing each toner were produced.

The contents of toner sets according to combinations of the toners and the exothermic peak top temperatures of the toners are shown Table VI described below.

With respect to the exothermic peak top temperature, a sample in an amount of 5 mg was sealed in an aluminum pan KIT NO. B0143013 and set in a sample holder of a thermal analyzer Diamond DSC (manufactured by PerkinElmer Inc.), and the temperature was changed by heating, cooling, and heating in this order. The temperature was increased from 0° C. to 100° C. at a temperature increase rate of 10° C./min to retain the temperature at 100° C. for one minute during the first and second heating, and the temperature was decreased from 100° C. to 0° C. at a temperature decrease rate of 10° C./min to retain the temperature at 0° C. for one minute during the cooling. The temperature at the exothermic peak top in an endothermic curve which was obtained during the cooling was determined to be the “exothermic peak top temperature”.

TABLE 6
Table VI

| | | | Physical property of toners | | | | |
|---|---|---|---|---|---|---|---|
| | Toner set composition | | Exothermic peak top | | | | |
| Toner | Type | Type | temperature (° C.) | | | | |
| set No. | No. | No. | Y | M | C | Bk | Note |
| 1 | Color toners | Black toner Bk1 | 80.2 | 80.6 | 81.1 | 79.1 | Example 1 |
| | Y1, C1, M1 | | | | | | |
| 2 | Color toners | Black toner Bk2 | 78.2 | 78.4 | 78.7 | 75.7 | Example 2 |
| | Y2, C2, M2 | | | | | | |
| 3 | Color toners | Black toner Bk2 | 80.2 | 80.6 | 81.1 | 75.7 | Example 3 |
| | Y1, C1, M1 | | | | | | |
| 4 | Color toners | Black toner Bk3 | 85.2 | 85.6 | 86.1 | 84.1 | Example 4 |
| | Y3, C3, M3 | | | | | | |
| 5 | Color toners | Black toner Bk2 | 85.2 | 85.6 | 86.1 | 75.7 | Example 5 |
| | Y3, C3, M3 | | | | | | |
| 6 | Color toners | Black toner Bk4 | 79.3 | 80.4 | 81.0 | 75.9 | Example 6 |
| | Y4, C4, M4 | | | | | | |
| 7 | Color toners | Black toner Bk2 | 79.3 | 80.4 | 81.0 | 75.7 | Example 7 |
| | Y4, C4, M4 | | | | | | |
| 8 | Color toners | Black toner Bk5 | 73.2 | 74.3 | 74.9 | 70.0 | Example 8 |
| | Y5, C5, M5 | | | | | | |
| 9 | Color toners | Black toner Bk6 | 67.8 | 68.9 | 69.5 | 64.4 | Comparative |
| | Y6, C6, M6 | | | | | | Example 1 |
| 10 | Color toners | Black toner Bk3 | 80.2 | 79.4 | 78.2 | 84.1 | Comparative |
| | Y2, C7, M7 | | | | | | Example 2 |
| 11 | Color toners | Black toner Bk7 | 91.2 | 91.8 | 92.3 | 89.6 | Comparative |
| | Y8, C8, M8 | | | | | | Example 3 |

«Evaluation Method»

[Wax Adhesion Property]

In a commercially available color multifunction printer AccurioPress C3080 (manufactured by KONICA MINOLTA, INC.), the fixing apparatus was modified in such a way that the surface temperature of the fixing upper belt could be changed in the range of 140 to 220° C., and the surface temperature of the fixing lower roller can be changed in the range of 120 to 200° C. The developing agents were sequentially loaded in this modified machine, and a solid image with an amount of the toner adhering of 8.0 g/m² was formed on A4 (basis weight 157 g/m²) gloss coat paper in a normal temperature/normal humidity (temperature 20° C., humidity 50% RH) environment, and fixation processing was performed. The fixing speed was set to 460 mm/sec, the fixing temperature (surface temperature of fixing upper belt) was set to the under-offset temperature +35° C. during the fixation processing.

The state of adhesion of wax to the conveyance roller after printing 100 sheets was visually evaluated by rank in 10 grades as described below, and rank 7 or higher was regarded as passed. Rank 10 to 9: Adhesion of wax is not recognized at all

Rank 8 to 7: A level such that there is no problem with product quality although adhesion of wax is somewhat recognized5

Rank 6 to 1: A practically unusable level such that adhesion of wax is recognized

[Gloss Memory Property]

The gloss memory refers to an image failure such that a release agent which has adhered to a fixing member during continuous paper feeding is placed on the next image and a history of the prior image appears as a gloss difference.

In a commercially available color multifunction printer AccurioPress C3080 (manufactured by KONICA MINOLTA, INC.), the fixing apparatus was modified in such a way that the pressure in the nip region could be changed, the surface temperature of the heat roller for fixation (fixing roller) can be changed in the range of 100 to 210° C., and the process speed (nip time) can be changed, and the respective developing agents produced from the toners were each loaded.

On each of the developing agents produced from the toners, a fixing experiment of outputting an image (output image of alphabet) for evaluating gloss memory with an amount of the toner adhering of 8 g/m² on A3-sized coated paper Esprit C 209 g/m² (manufactured by Nippon Paper Industries Co., Ltd.) in a normal temperature/normal humidity (temperature 20° C., humidity 50% RH) environment under a condition that the nip pressure of the fixing device was 238 kPa and the nip time was 25 milliseconds (process speed 480 mm/s) was performed repeatedly while changing the fixing temperature to be set by 10° C. at a time from 160° C. to 200° C.

The evaluation criteria are as follows, and AA to CC are practically usable.

AA: Gloss memory does not occur at all in any of the samples

BB: Gloss memory somewhat occurs in every sample but is at an acceptable level (mist is thinly seen)

CC: Gloss memory somewhat occurs in every sample but is at an acceptable level (alphabet is thinly seen)

DD: Gloss memory occurs remarkably in every sample (contours of alphabet can be recognized)

[Fixation Separability]

«Thin Paper Separability (Separable End Margin Quantity)»

An image forming apparatus obtained by modifying a commercially available color multifunction printer AccurioPress C3080 (manufactured by KONICA MINOLTA, INC.) in such a way that the surface temperatures of the fixing upper belt and the fixing lower roller could be changed was used as an image forming apparatus, and the respective two-component developing agents of the colors were sequentially loaded. The apparatus was modified in such a way that the fixing temperature, the amount of the toner adhering, and the system speed could freely be set. OK TopKote +85 g/m² (manufactured by Oji Paper Co., Ltd.) was used as evaluation paper. A temperature (U. O. avoiding temperature +25° C.) obtained by increasing temperature by 25° C. from a temperature (U. O. avoiding temperature), as a standard, at which under offset does not occur was determined to be the temperature of the fixing upper belt; the temperature of the fixing lower roller was set to 90° C.; respective full solid images (amount adhering 8.0 g/m²) were each output changing the end margin quantity; and the end margin quantity immediately before a paper jam (jam) occurred was used as a scale of thin paper separation performance. The smaller the value of the separable end margin quantity is, the better the separation performance is. It is to be noted that the evaluation was carried out in a normal temperature/normal humidity environment (NN environment: temperature 25° C., humidity 50% RH). Moreover, smaller separable end margin means more excellent thin paper separability, and when the end margin is less than 5.5 mm, the fixation separability is determined as passed (AA or BB).

(Evaluation Criteria)

AA: Separable end margin is less than 2 mm

BB: Separable end margin is 2 mm or more and less than 5.5 mm

CC: Separable end margin is 5.5 mm or more and less than 10 mm

DD: Separable end margin is 10 mm or more

Evaluation results of the toner sets 1 to 11 are shown in Table VII described below.

TABLE 7
Table VII

| | Evaluation results | | | |
|---|---|---|---|---|
| | | | Fixation | |
| | Wax adhesion | | separability | |
| | property | Gloss memory | End margin | |
| Toner | Rank: 7 or | Rank: BB or | (mm) 5 mm or | |
| set No. | higher Pass | higher Pass | less Pass | Note |
| 1 | 9 | AA | 1 mm | Example 1 |
| 2 | 10 | BB | 3 mm | Example 2 |
| 3 | 9 | AA | 1 mm | Example 3 |
| 4 | 10 | BB | 2 mm | Example 4 |
| 5 | 10 | BB | 2 mm | Example 5 |
| 6 | 8 | AA | 5 mm | Example 6 |
| 7 | 8 | AA | 4 mm | Example 7 |
| 8 | 7 | AA | 3 mm | Example 8 |
| 9 | 4 | AA | 3 mm | Comparative |
| | | | | Example 1 |
| 10 | 6 | DD | 5 mm | Comparative |
| | | | | Example 2 |
| 11 | 10 | DD | 6 mm | Comparative |
| | | | | Example 3 |

It is found from Table VII that the toner sets of Examples 1 to 8 according to the present invention are excellent in the wax adhesion property, the gloss memory, and the fixation separability.

Although embodiments of the present invention have been described and illustrated in detail, the disclosed embodiments are made for purposes of illustration and example only and not limitation. The scope of the present invention should be interpreted by terms of the appended claims

What is claimed is:

1. An electrostatic latent image developing toner set comprising at least a yellow toner, a magenta toner, and a cyan toner, wherein
when exothermic peak top temperatures during decreasing temperature in differential scanning calorimetry of the yellow toner, the magenta toner, and the cyan toner are assumed to be P(Y), P(M), and P(C), respectively, the exothermic peak top temperatures satisfy the following expression (1):
70≤P(Y)≤P(M)≤P(C)≤90 (° C.) (1).

2. An electrostatic latent image developing toner set comprising at least a black toner, a yellow toner, a magenta toner, and a cyan toner, wherein
when exothermic peak top temperatures during decreasing temperature in differential scanning calorimetry of the black toner, the yellow toner, the magenta toner, and the cyan toner are assumed to be P(Bk), P(Y), P(M), and P(C), respectively, the exothermic peak top temperatures satisfy the following expression (2):
70≤P(Bk)≤P(Y)≤P(M)≤P(C)≤90 (° C.) (2).

3. The electrostatic latent image developing toner set according to claim 2, wherein the exothermic peak top temperatures of the black toner, the yellow toner, the magenta toner, and the cyan toner during decreasing temperature in differential scanning calorimetry of the toners satisfy the following expressions (3) to (6):
70≤P(Bk)≤85 (° C.) (3);
72≤P(Y)≤86 (° C.) (4);
73≤P(M)≤87 (° C.) (5); and
74≤P(C)≤88 (° C.) (6).

4. The electrostatic latent image developing toner set according to claim 1, wherein the toners each comprise at least a styrene/acrylic resin as a binder resin.

5. The electrostatic latent image developing toner set according to claim 1, wherein the toners each comprise at least a crystalline resin as a binder resin.

6. The electrostatic latent image developing toner set according to claim 5, wherein the crystalline resin comprises a crystalline polyester.

7. An electrophotographic image forming method using at least a yellow toner, a magenta toner, and a cyan toner, wherein the electrostatic latent image developing toner set according to claim 1 is used.

8. The electrostatic latent image developing toner set according to claim 2, wherein the toners each comprise at least a styrene/acrylic resin as a binder resin.

9. The electrostatic latent image developing toner set according to claim 2, wherein the toners each comprise at least a crystalline resin as a binder resin.

10. The electrostatic latent image developing toner set according to claim 9, wherein the crystalline resin comprises a crystalline polyester.

11. An electrophotographic image forming method using at least a yellow toner, a magenta toner, and a cyan toner, wherein
the electrostatic latent image developing toner set according to claim 2 is used.
